(19) United States
(12) Patent Application Publication
(10) Pub. No.: US 2017/0083987 A1
(43) Pub. Date: Mar. 23, 2017

(54) REAL-TIME COST MANAGEMENT FOR UTILITIES

(71) Applicant: Intel IP Corporation, Santa Clara, CA (US)

(72) Inventors: Robert Colby, Granite Bay, CA (US); Anand Muralidharan, Bangalore (IN); Sidney Lam, Hillsboro, OR (US); Swati Hily, Portland, OR (US)

(21) Appl. No.: 14/860,280

(22) Filed: Sep. 21, 2015

(51) Int. Cl. G06Q 50/06; G06Q 30/02

(52) U.S. Cl. CPC G06Q 50/06; G06Q 30/0283

(57) ABSTRACT

Example methods, apparatus and articles of manufacture (e.g., physical storage media) to perform real-time cost management for utilities are disclosed. Disclosed example methods for real-time utility cost management include displaying, on a display associated with an appliance, utility pricing data received via a network. Such disclosed example methods also include, after displaying the utility pricing data, determining, based on a first input received via a user interface associated with the appliance, whether remote control of the appliance is permitted. Such disclosed example methods further include, in response to determining that remote control of the appliance is permitted, delaying activation of an operation of the appliance until receipt of a first command via the network.

### FIELD OF THE DISCLOSURE

This disclosure relates generally to cost management for utilities and, more particularly, to real-time cost management for utilities, including public utilities.

### BACKGROUND

Utility providers, such as public utility companies, are faced with the challenge of managing the delivery of utility resources (electric power, water, natural gas, etc.) to meet the needs of ever-growing metropolitan populations having consumption demands that vary (sometimes widely) over time. Today, some utility providers have tiered pricing models that enable the utility providers to influence consumption of utility resources by their customers. For example, an electric power utility company may charge a customer (e.g., a homeowner, a business, an educational institution, a governmental institution, etc.) more for electricity consumption during peak times than during non-peak times in an effort to reduce the customer's electric power consumption during the peak times. As another example, a water utility company may increase the amount a customer is charged for water consumption after a threshold number of gallons has been consumed by the customer during a billing period in an effort to reduce the customer's overall water consumption during the billing period.

### BRIEF DESCRIPTION OF THE DRAWINGS

FIG. 1 is an example power consumption curve that demonstrates varying power demand over time.

FIG. 2 is a block diagram of an example system supporting real-time cost management for utilities in accordance with the teachings of this disclosure.

FIG. 3 is a block diagram of an example active control interface that may be used with example appliances in the example system of FIG. 2 to support real-time cost management for utilities in accordance with the teachings of this disclosure.

FIG. 4 is a block diagram of an example passive display interface that may be used with example utility delivery interfaces in the example system of FIG. 2 to support real-time cost management for utilities in accordance with the teachings of this disclosure.

FIG. 5 is a block diagram of an example utility gateway that may be included in the example system of FIG. 2 to support real-time cost management for utilities in accordance with the teachings of this disclosure.

FIG. 6 is a block diagram of an example utility pricing manager that may be included in the example system of FIG. 2 to support real-time cost management for utilities in accordance with the teachings of this disclosure.

FIG. 7 is a flowchart representative of example machine readable instructions that may be executed to implement the example active control interface of FIG. 3.

FIG. 8 is a flowchart representative of example machine readable instructions that may be executed to implement the example passive display interface of FIG. 4.

FIG. 9 is a flowchart representative of example machine readable instructions that may be executed to implement the example utility gateway of FIG. 5.

FIG. 10 is a flowchart representative of example machine readable instructions that may be executed to implement the example utility pricing manager of FIG. 6.

FIG. 11 is a flowchart representative of an example real-time cost management process flow capable of being performed in the example system of FIG. 2.

FIG. 12 is a block diagram of an example processor platform structured to execute the example machine readable instructions of FIG. 7 to implement the example active control interface of FIG. 3.

FIG. 13 is a block diagram of an example processor platform structured to execute the example machine readable instructions of FIG. 8 to implement the example passive display interface of FIG. 4.

FIG. 14 is a block diagram of an example processor platform structured to execute the example machine readable instructions of FIG. 9 to implement the example utility gateway of FIG. 5.

FIG. 15 is a block diagram of an example processor platform structured to execute the example machine readable instructions of FIG. 10 to implement the example utility pricing manager of FIG. 6.

The figures are not to scale. Wherever possible, the same reference numbers will be used throughout the drawing(s) and accompanying written description to refer to the same or like parts, elements, etc.

### DETAILED DESCRIPTION

Methods, apparatus and articles of manufacture (e.g., physical storage media) to perform real-time cost management for utilities are disclosed herein. Disclosed example methods for real-time utility cost management (e.g., which may be implemented by an example active control interface for an appliance) include displaying, on a display associated with an appliance, utility pricing data received via a network (e.g., from a utility provider). Such disclosed example methods also include, after displaying the utility pricing data, determining, based on a first input received via a user interface associated with the appliance, whether remote control of the appliance (e.g., by the utility provider) is permitted. Such disclosed example methods further include, in response to determining that remote control of the appliance is permitted, delaying activation of an operation of the appliance until receipt of a first command via the network. For example, the first command may be received from the utility provider providing the utility pricing data.

Some such disclosed example methods include, after delaying the activation of the operation of the appliance, activating the operation of the appliance in response to receipt of the first command via the network (e.g., from the utility provider). Some such disclosed example methods also include, after the operation of the appliance is activated, deactivating the operation of the appliance in response to receipt of a second command via the network (e.g., from the utility provider).

Additionally or alternatively, in some such disclosed example methods, the utility pricing data is first pricing data associated with a first time. Some such disclosed example methods also include displaying second utility pricing data expected to be charged for providing a utility resource to the appliance at a second time later than the first time if remote control of the appliance is permitted, with the second utility pricing data being received via the network (e.g., from the utility provider). Some such disclosed example methods further include, when remote control of the appliance is permitted, displaying third utility pricing data received via the network (e.g., from the utility provider) in association with the first command. In some such disclosed examples, the third utility pricing data indicates an actual price to be charged for providing the utility resource to the appliance at the second time.

Additionally or alternatively, some such disclosed example methods include specifying, based on a second input received via the user interface, a duration over which the operation of the appliance is to be active. Such disclosed example methods also include transmitting, via the network (e.g., to the utility provider), information describing the duration over which the operation of the appliance is specified to be active. Such disclosed example methods further include activating and deactivating the operation of the appliance over a sequence of time intervals based on a sequence of commands received via the network (e.g., from the utility provider), with the sequence of time intervals cumulatively corresponding to the duration over which the operation of the appliance is specified to be active.

Additionally or alternatively, some such disclosed example methods include metering utility resource consumption associated with the appliance. Some such disclosed example methods also include reporting the utility resource consumption associated with the appliance via the network (e.g., to the utility provider, to a utility gateway at a customer's premises, etc.).

Other disclosed example methods for real-time utility cost management (e.g., which may be implemented by an example passive display interface for use with utility delivery interfaces, such as an electrical outlet) include accessing, with a processor, real-time pricing data for providing electrical power to an electrical outlet, with the real-time pricing data being received via a network (e.g., from a utility provider). Such disclosed example methods also include displaying, on a display, the real-time pricing data. In some such examples, the processor and the display are powered by a power supply circuit electrically coupled with wiring of the electrical outlet.

Some such disclosed example methods further include receiving the real-time pricing data via a wireless transceiver in communication with the processor and the network. In some examples, the wireless transceiver is also powered by the power supply circuit. Furthermore, in some such disclosed examples, the power supply circuit is electrically coupled with a first electrical plug that is to electrically couple with a first electrical socket of the electrical outlet to thereby electrically couple with the wiring of the electrical outlet. In some such disclosed examples, the processor, the display, the power supply circuit, the wireless transceiver and the first electrical plug are housed in a housing. In some such disclosed examples, the housing further houses a second electrical socket electrically coupled to the first electrical plug.

Still other disclosed example methods for real-time utility cost management (e.g., which may be implemented by an example utility gateway associated with a customer's premises) include accessing first utility pricing data provided by a utility provider via a first network (e.g., a broadband network, the Internet, etc.). Such disclosed example methods also include relaying, via a second network (e.g., a local area network, a wireless network, etc.) the first utility pricing data to a control interface associated with an appliance. Such disclosed example methods further include relaying a first command received, after the first utility pricing data, from the utility provider, via the first network, to the control interface associated with the appliance, via the second network, to control an operation of the appliance.

Some such disclosed example methods also include, prior to the relaying of the first command, relaying a second command received from the control interface associated with the appliance, via the second network, to the utility provider, via the first network, to specify whether remote control of the appliance is permitted. Additionally or alternatively, in some such disclosed examples, the first command is to activate the operation of the appliance. Some such disclosed example methods further include, after the relaying of the first command, relaying a second command received from the utility provider, via the first network, to the control interface associated with the appliance, via the second network, to deactivate the operation of the appliance.

Additionally or alternatively, in some such disclosed examples, the first utility pricing data is associated with a first time. Some such disclosed example methods also include accessing, via the first network, second utility pricing data expected to be charged for providing a utility resource to the appliance at a second time later than the first time if remote control of the appliance is permitted. Some such disclosed example methods further include relaying, via the second network, the second utility pricing data with the first utility pricing data to the control interface associated with the appliance. Furthermore, some such disclosed example methods include accessing third utility pricing data received via the first network in association with the first command, with the third utility pricing data indicating an actual price to be charged for providing a utility resource to the appliance at the second time. Some such disclosed example methods also include relaying, via the second network, the third utility pricing data to the control interface associated with the appliance.

Additionally or alternatively, some such disclosed example methods including displaying metering data reported by the appliance via the second network. For example, the metering data may characterize utility resource consumption associated with the appliance.

Yet other disclosed example methods for real-time utility cost management (e.g., which may be implemented by an example utility pricing manager associated with a utility provider) include transmitting, via a network, first utility pricing data to a gateway (e.g., at a customer's premises). Such disclosed example methods also include detecting an event associated with providing a utility resource, and determining second utility pricing data based on the event. Such disclosed example methods further include transmitting, via the network, the second utility pricing data to the gateway. For example, the event may correspond to one or more of (1) expiration of a timer, (2) recovery from an overload condition, (3) occurrence of a fault condition, etc.

Some such disclosed example methods also include receiving, via the network (e.g., from the gateway), a first command indicating that remote control of a first appliance in communication with the gateway is permitted. Some such disclosed example methods further include, in response to the detection of the event, transmitting, via the network, a second command to the gateway to control an operation of the first appliance. In some such disclosed example methods, the second command is to cause activation of the operation of the first appliance at a first time, and the methods further including transmitting, via the network, third utility pricing data to the gateway, with the third utility pricing data indicating an actual price to be charged for providing the utility resource to the first appliance at the first time. Additionally or alternatively, in some such disclosed example methods, the second command is to cause activation of the operation of the first appliance, and the methods further include, after the transmission of the second command, transmitting, via the network, a third command to the gateway to cause deactivation of the operation of the first appliance.

Additionally or alternatively, some such disclosed example methods include receiving, via the network (e.g., from the gateway), information describing a duration over which an operation of a first appliance is specified to be active. Such disclosed example methods also include transmitting, via the network, a sequence of commands to the gateway to activate and deactivate the operation of the first appliance over a sequence of time intervals, with the sequence of time intervals cumulatively corresponding to the duration over which the operation of the first appliance is specified to be active.

Additionally or alternatively, some such disclosed example methods include accessing metering data received from multiple appliances via the network, with the metering data characterizing resource consumption associated with respective ones the appliances. Some such disclosed example methods also include processing the metering data to detect the event associated with providing the utility resource.

These and other example methods, apparatus, systems and articles of manufacture (e.g., physical storage media) to perform real-time utility cost management are disclosed in greater detail below.

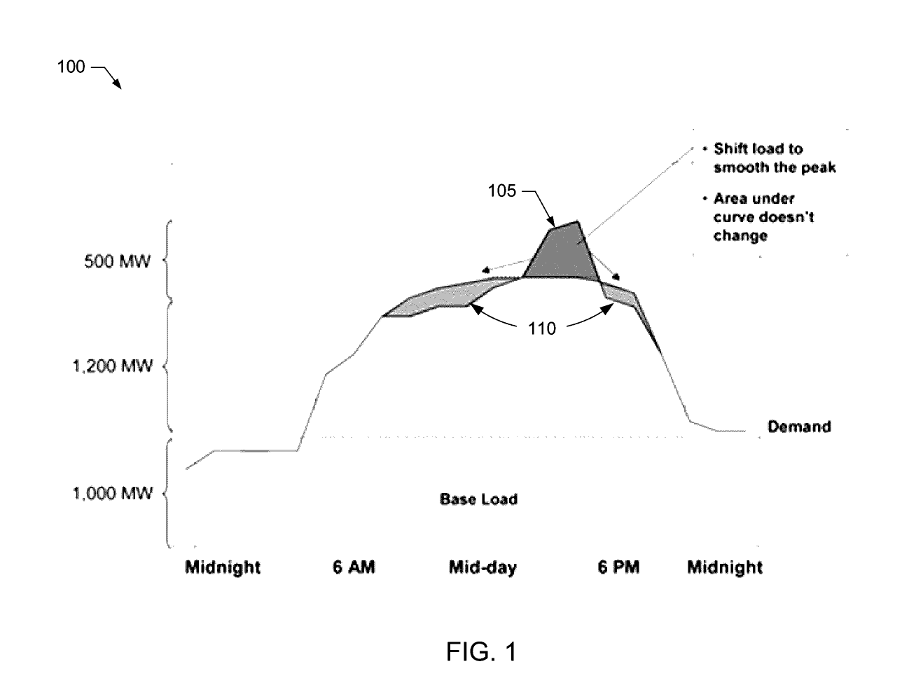

As mentioned above, utility providers face the challenge of managing the delivery of utility resources (electric power, water, natural gas, etc.) to meet the needs of ever-growing metropolitan populations having consumption demands that vary (sometimes widely) over time. FIG. 1 illustrates an example power consumption curve 100 that demonstrates varying power consumption demand for an example population over time. The example power consumption curve 100 of FIG. 1 depicts a challenge faced by electric power utility companies, namely, to avoid “brown outs” or “black outs” during peak consumption time intervals. If electric power utility companies could shift, as illustrated in the example of FIG. 1, resource consumption that would typically occur during peak usage times, such as during the illustrated example time period 105, to other times, such as the illustrated example time periods 110, the risk of such “brown outs” or “black outs” may be reduced. However, electric power utility companies, and utility providers, in general, lack the technical capabilities to effect such real-time shifts in their customer's resource consumption behavior today.

Additionally, research by the inventors indicates that there could be substantial reduction in utility costs for customers (e.g., such as a 10% average reduction, in some examples), as well as for utility providers, if customers could have access to real-time utility pricing data. However, utility providers, in general, lack the technical capabilities to provide such real-time utility pricing data to their customers today.

Example methods, apparatus, systems and articles of manufacture (e.g., physical storage media) disclosed herein to perform real-time utility cost management provide technical solutions to the foregoing, and other, technical problems by implementing example mechanisms for providing real time pricing visibility from a utility provider to a customer. In some examples, such real time pricing visibility is provided down to the appliance level (e.g., at the time the customer wants to activate the appliance by, for example, pushing a button). Such disclosed examples enable a customer to make a more educated decision at the time of action. Additionally or alternatively, example methods, apparatus, systems and articles of manufacture (e.g., physical storage media) disclosed herein to perform real-time utility cost management provide example methodologies for implementing real-time utility pricing structures (in contrast with prior “timed” and “tiered” pricing structures). Additionally or alternatively, example methods, apparatus, systems and articles of manufacture (e.g., physical storage media) disclosed herein to perform real-time utility cost management enable utility providers to directly manage operation of customer appliances, such as to take actions at desired (e.g., optimum) times, thereby improving overall efficiency of utility (e.g., power) consumption at an individual customer's premises, as well as over a metropolitan area.

Real-time utility cost management as disclosed herein is different from utility metering using prior smart meters. Prior smart meters are typically simple devices that upload utility resource (e.g., electric power, water, natural gas, etc.) usage information from a customer's premises to a utility provider to report the amount of resources as a whole the customer premises has consumed over a period of time. Real-time utility cost management as disclosed herein is also different from prior appliance management based on timers. Such timers are typically simple devices that are limited to specifying on/off settings for appliances to align resource consumption with predictable usage patterns (e.g., consistent with prior “timed” and “tiered” pricing structures set by a utility companies).

In contrast, real-time utility cost management, as disclosed herein, enables far more intelligence at the customer premises (e.g., in the home), and enables far more direct influence from utility providers to manage a metropolitan area's utility ecosystem more effectively. Real-time utility cost management, as disclosed herein, also provides methodologies to plug in existing devices (e.g., appliances), as well as future devices, into a utility ecosystem, which allows utility providers to directly control, in real-time, resource management across a metropolitan area.

For example, unlike prior smart meter and/or timer based systems, real-time utility cost management, as disclosed herein, enables a utility provider facing gas delivery problems due to a broken line to adjust gas delivery costs in real-time in an attempt to reduce consumption. Additionally or alternatively, in some examples, real-time utility cost management, as disclosed herein, enables the utility provider to directly control customer appliances (such as dryers in customers' homes) to not start operation until the broken line is repaired.

As another example, unlike prior smart meter and/or timer based systems, real-time utility cost management, as disclosed herein, enables a customer (e.g., such as a homeowner) to see, via an example active control interface (e.g., a smart panel) on his/her appliance, such as an oven, the real-time cost to operate the oven as he/she is about to activate oven operation by pressing a button on the active control interface. Such an active control interface can benefit the utility provider and the customer as it enables the utility provider to influence the customer's decisions concerning utility resource (e.g., natural gas) consumption, and also enables the customer to make more educated decisions concerning utility resource consumption. In some examples, such an active control interface enables automated decisions by the appliance (e.g., oven) itself.

Today, when a customer logs in to view what the customer's smart meter is reporting to a utility company, the customer may be able to see, for example, how much electric power the customer's premises (e.g., home) is consuming as a whole. In contrast, in some examples of real-time utility cost management disclosed herein, the customer can log into a utility gateway at the customer's premises to view how much electric power is being consumed at the individual device level, the individual electric outlet level, etc.

As another example of the potential benefits associated with real-time utility cost management as disclosed herein, consider a pool filtration system. Today, pool filtration systems are typically managed (e.g., activated and deactivated) with timers that may be aligned with static pricing tiers set by a utility provider. Also, such pool timers are usually configured manually. In contrast with such timer based systems, real-time utility cost management as disclosed herein enables the utility provider to directly manage pool filtration system operating times to be optimized around, for example, times at which the utility provider can provide electric power for lower cost. In some such examples, a customer (e.g., a homeowner) could configure how many hours per day he/she wants the pool filtration system to run, and the utility provider can then configure the pool filtration system to run at one or more times (e.g., a sequence of different times throughout the day) that have lower utility impact, but still meet the overall time configured by the homeowner. Such operation should have negligible impact to the consumer, whose primary goal is to have the pool filtration system run for a certain overall amount of time day (vs. being run at specific times), and yet achieve potentially substantial cost savings for the homeowner and the utility company.

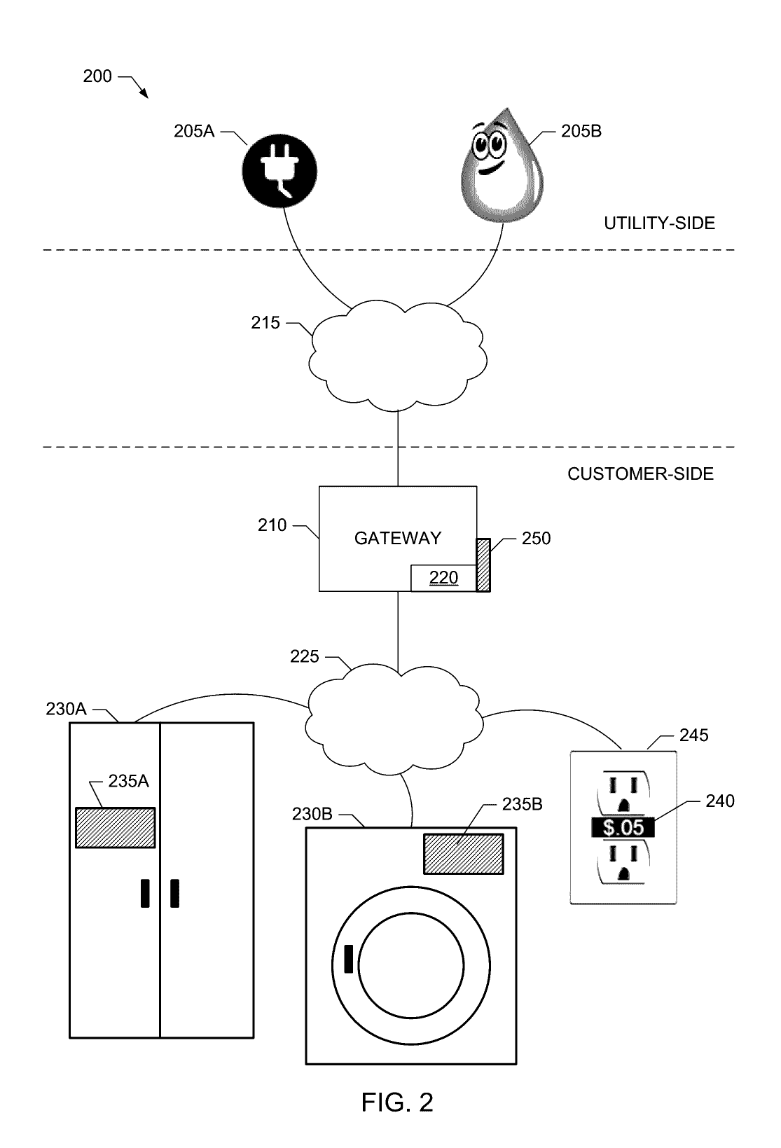

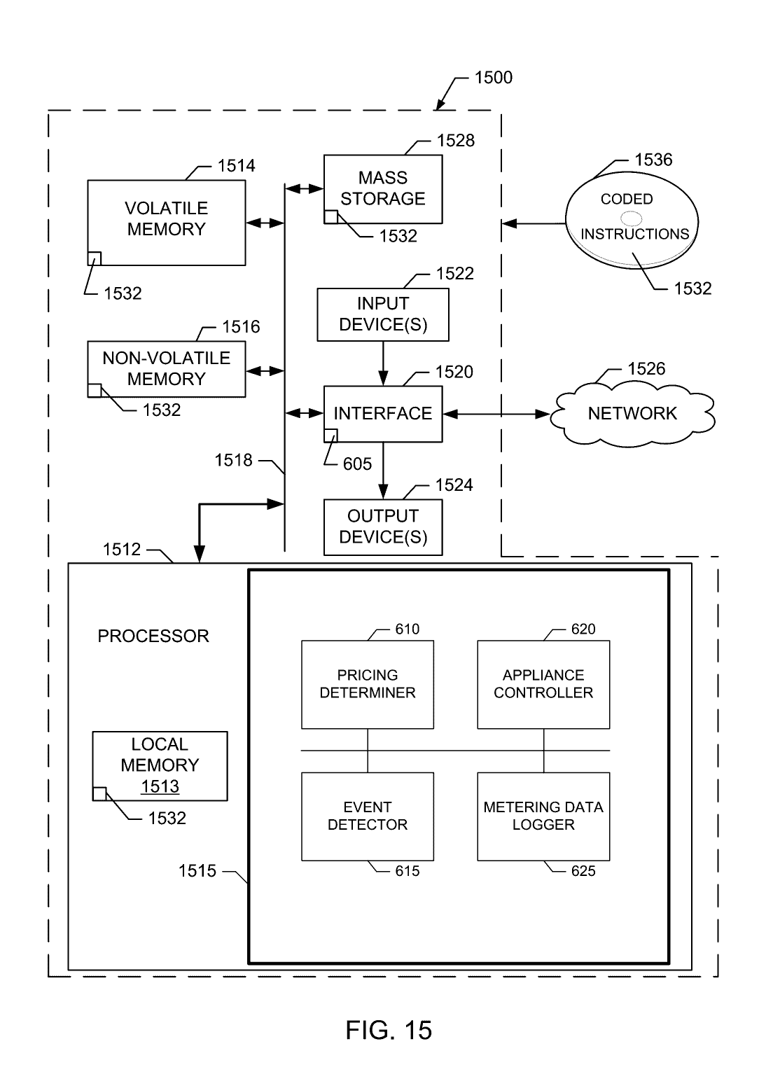

Turning to the figures, a block diagram of an example system 200 capable of supporting real-time utility cost management in accordance with the teachings of this disclosure is illustrated in FIG. 2. The example system 200 includes example utility pricing managers 205A-B, which are associated with respective utility providers, such as an example electric power utility company and a water utility company, as shown in the illustrated example. As disclosed in further detail below, the utility pricing managers 205A-B perform real-time utility cost management functions, such as conveying real-time utility pricing data to customers, remotely controlling customer appliances, etc. For example, the utility pricing managers 205A-B may convey updates to utility costs and/or send commands to customer appliances in real-time, and possibly in response to detection of one or more events associated with providing utility resources (e.g., electric power, water, natural gas, etc.), to customers' premises. The example utility pricing managers 205A-B may be implemented by one or more servers, processors, hardware, etc. For example, one or more of the utility pricing managers 205A-B may be implemented by a processor platform, such as the example processor platform 1500 of FIG. 15, which is described in further detail below. An example implementation of one or more of the utility pricing managers 205A-B is illustrated in FIG. 6, which is described in further detail below.

The example system 200 also includes an example utility gateway 210 associated with customer premises, which is in communication with one or more of the utility pricing managers 205A-B of the utility provider via a first example network 215. The first example network 215 may be implemented by any type(s) and/or number of communication networks, such as, for example, the Internet, one or more broadband networks, one or more wireless (e.g., cellular) networks, etc. As used herein, the phrase “in communication,” including variants thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

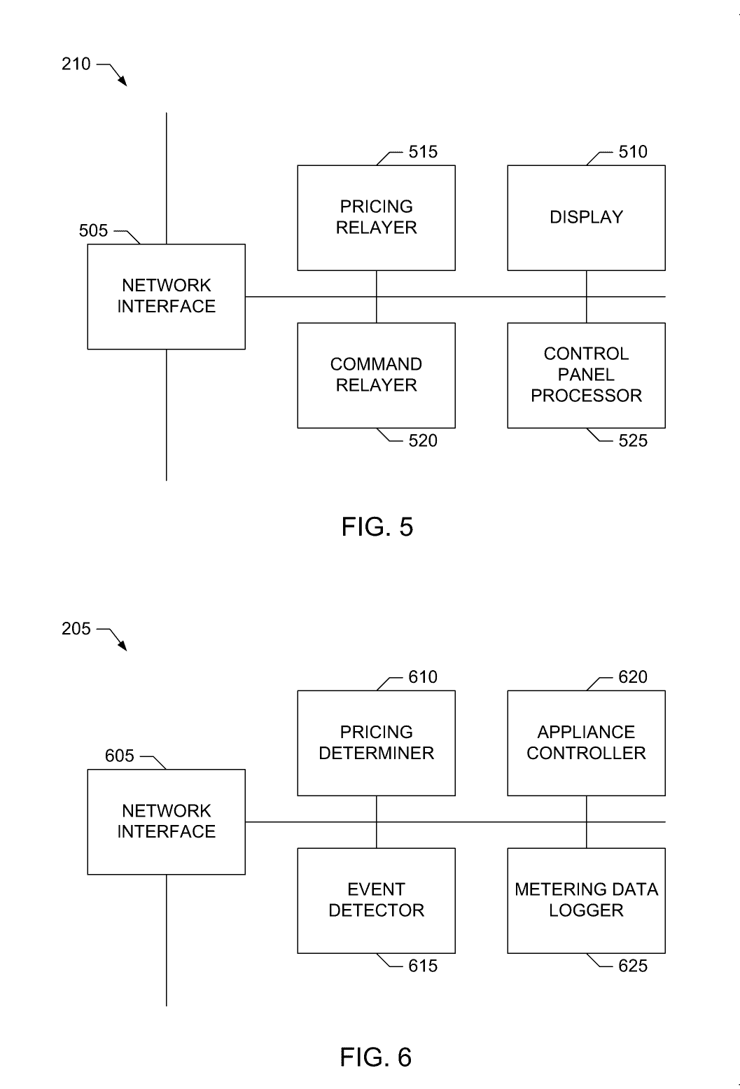

In the illustrated example of FIG. 2, the utility gateway 210 connects, via the first example network 115, to one or more of the utility pricing managers 205A-B to enable the utility pricing managers 205A-B to implement real-time utility cost management functions at the customer premises. Such example functions may include, but are not limited to: (1) the utility pricing managers 205A-B providing real time utility pricing data to the utility gateway 210 for presentation to the customer and/or relaying to one or more appliances in the customer's premises, (2) the utility pricing managers 205A-B sending control commands to the utility gateway 210 for relaying to the customer's appliance(s) that have been configured to “opt in” for remote control by the respective utility providers (in some examples, such “opt in” can be incentivized), (3) the utility pricing managers 205A-B receiving metering data relayed by utility gateway 210 from the customer's appliance(s), etc. The example utility gateway 210 may be implemented by one or more servers, processors, hardware, etc. For example, the utility gateway 210 may be implemented by a processor platform, such as the example processor platform 1400 of FIG. 15, which is described in further detail below. In some examples, the utility gateway 210 is implemented by an example “plug-in” module 220 (e.g., a downloaded app) within another gateway infrastructure (e.g., a broadband router, a set-top box, etc.) present at the customer premises. An example implementation of the utility gateway 210 is illustrated in FIG. 5, which is described in further detail below.

In the illustrated example of FIG. 2, the example utility gateway 210 implements an example open interconnect consortium (OIC) “utility” framework that enables smart home communications, via a second example network 225, between the utility gateway 210 gateway and “smart utility” devices also supporting the OIC utility framework. The second example network 225 can be implemented by any type(s) and/or number of communication networks, such as, for example, a local area network (LAN), a wireless LAN, an infrared network, an optical network, etc. For example, the OIC utility framework implemented by the utility gateway 210 can define a protocol for communicating over the second example network 225 using WiFi, ZigBee, Bluetooth, etc., which enables the utility gateway 210 to relay real time utility pricing data to smart appliances, relay control commands to smart appliances, receive utility resource metering data from smart appliances, etc. Although the example utility gateway 210 of FIG. 2 implements an OIC framework, real-time utility cost management, as disclosed herein, is not limited thereto. For example, the example utility gateway 210 can implement any other types and/or number of framework, in addition to or as an alternative to the OIC framework, to define one or more protocols for exchanging pricing data, commands, metering data, etc., over the second example network 225.

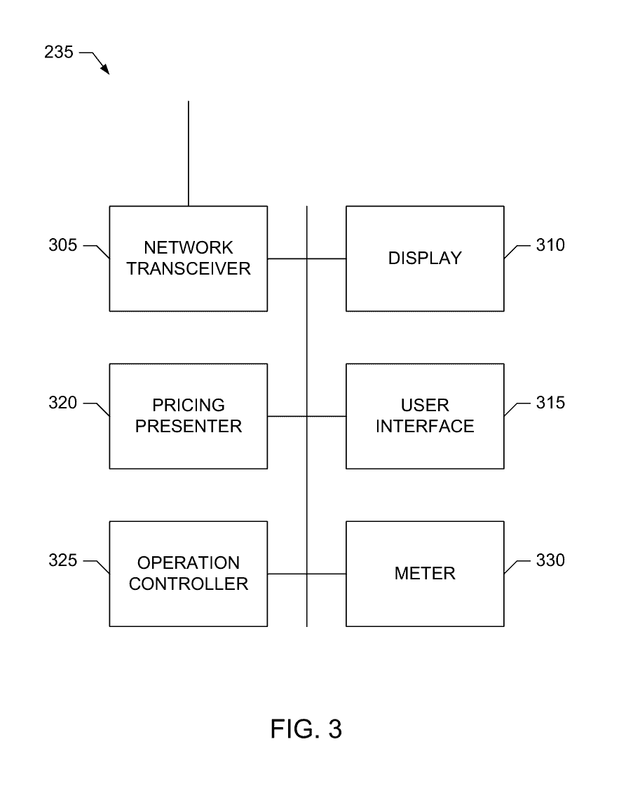

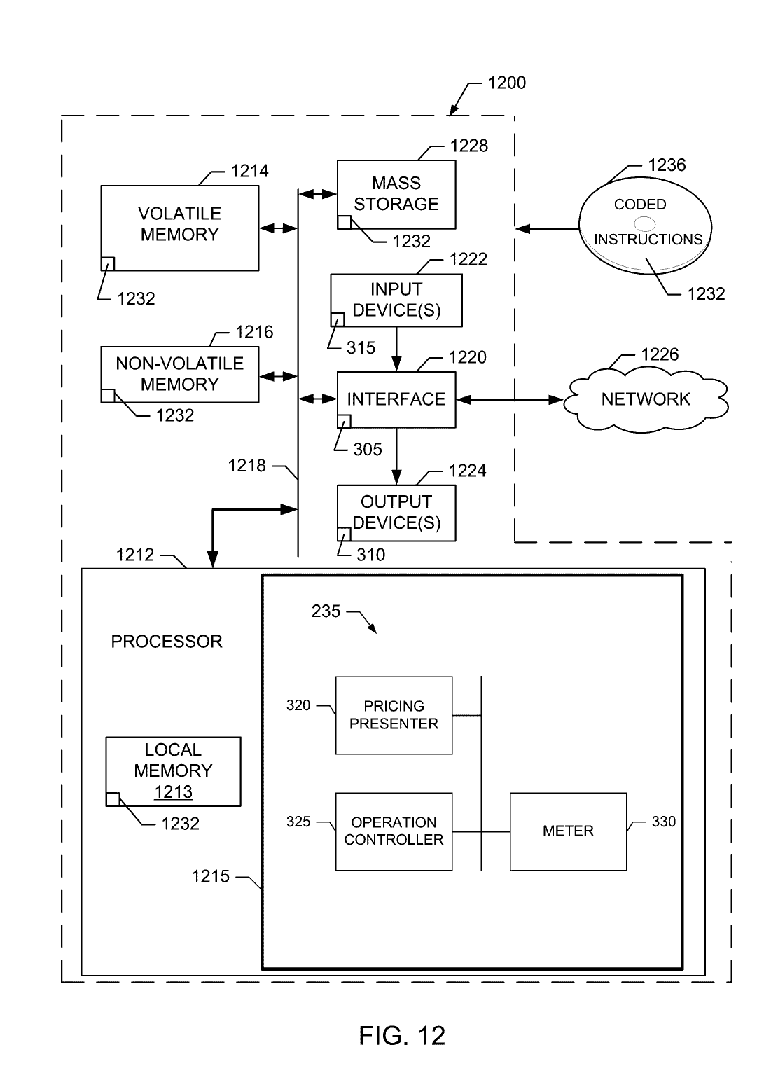

In the illustrated example of FIG. 2, the customer premises includes example appliances 230A-B associated with respective example active control interfaces 235A-B, which are in communication with the utility gateway 210 (e.g., using an OIC utility framework). The example appliances 230A-B can be implemented by any machines, devices, appliances, apparatus, etc., capable of consuming, measuring, receiving, etc., any type(s) and/or number of utility resources. The example active control interfaces 235A-B may be implemented by one or more servers, processors, hardware, etc. For example, one or more of the active control interfaces 235A-B may be implemented by a processor platform, such as the example processor platform 1200 of FIG. 12, which is described in further detail below. Moreover, the active control interfaces 235A-B may be integrated in or separate from (but in communication with) the respective appliances 230A-B. For example, one or more of the active control interfaces 235A-B may be implemented as an external unit constructed to interface with one or more existing appliances (via an external interface of the existing appliance, via modification of an existing appliance to gain access to a communication interface, etc.). An example implementation of one or more of the active control interfaces 235A-B is illustrated in FIG. 3, which is described in further detail below.

In the illustrated example of FIG. 2, the active control interfaces 235A-B enable (1) real-time utility pricing data to be displayed at the respective appliances 230A-B, (2) configuration of the respective appliances 230A-B to begin operation immediately or to opt-in for remote control by an appropriate utility provider (e.g., for remote control by one or more of the example utility pricing managers 205A-B), (3) determine and report metering data for resource usage by the respective appliances 230A-B, etc. For example, consider a smart appliance such as the example clothes driver 230B, which is associated with the active control interface 235B. In some examples, after clothes are loaded in the example dryer 230B, the example active control interface 235B displays at least two start options to the customer. For example, a first such start option could be a “Start Now” option (or similar option), which displays the real time utility cost (provided by an electric power utility provider via the example utility pricing manager 205A) if the customer activated operation the clothes dryer 230B immediately. A second such start option could be a “Start at Optimum Time” option (or similar option), which allows the utility provider to send (e.g., via the utility pricing manager 205A) an activation command to start the dryer at a later (e.g., optimum) time. The example active control interface 235B may also display what the utility cost is expected to be at that later time, and/or may also display the actual utility cost when the dryer 230B is activated remotely at that later time. Because the utility provider(s) can manage (e.g., via the example utility pricing managers 205A-B) the start times of appliances in the example system 200, the utility provider(s) can control when appliances start so that the utility provider(s) is(are) not subjected to unexpected additional loads, can reduce peak loads, etc.

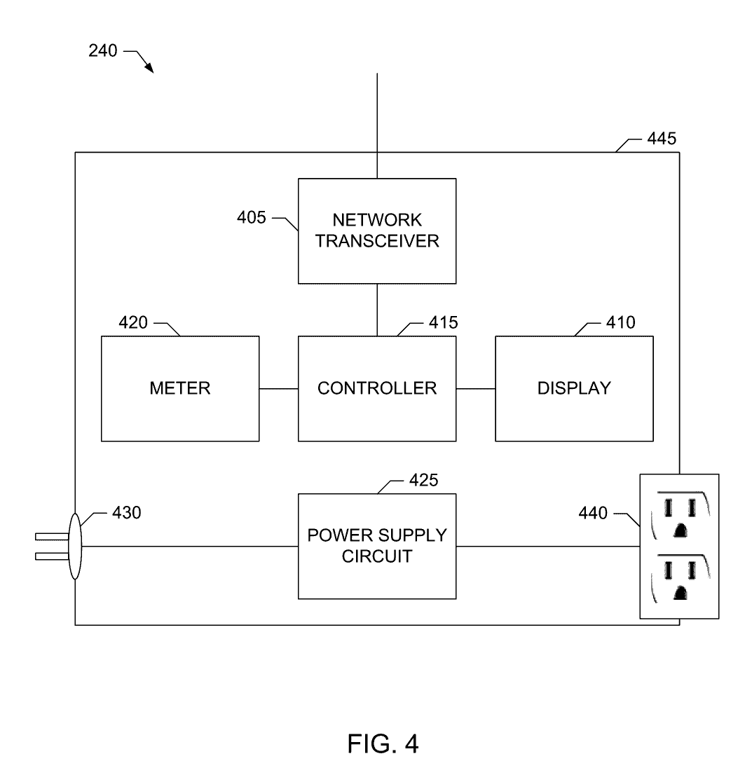

In the illustrated example of FIG. 2, the example system 200 includes one or more passive display interfaces, such as an example passive display interface 240, in communication with the example utility gateway 210 via the second example network 215 (e.g., using the OIC utility framework). Such example passive display interfaces 240 are constructed to display real-time utility pricing data at one or more utility delivery interfaces, such as an example utility delivery interface 245, at the customer premises. Examples of utility delivery interfaces include, but are not limited to, electrical outlets (e.g., wall outlets), water spigots, natural gas line connections, etc. Such example passive display interfaces 240 permit existing and/or other “non-smart” devices to benefit from real-time utility cost management as disclosed herein. In some examples, a passive display interface, such as the passive display interface 240, also includes a meter to determine and report metering data for resource usage at the utility delivery interface (e.g., at the electrical outlet, at the water spigot, at the natural gas line connection, etc.). An example implementation of the passive display interface 240 is illustrated in FIG. 4, which is described in further detail below.

In the example system 200 of FIG. 2, an example central control panel 250 is in communication with the example utility gateway 210 to allow the customer (e.g., homeowner) to have a global view of utility usage, costs, etc., at the customer premises. For example, the central control panel 250 can be integrated in (or otherwise implemented by) the utility gateway 210, or separate from but in communication with the utility gateway 210 via the second example network 215 (e.g., using the OIC utility framework), etc. In the illustrated example, the utility gateway 210 uses the example central control panel 250 to notify the customer of utility costs and/or usage in real-time, utility resource usage anomalies, such as unusual usage behavior indicative of water leaks, natural gas leaks, etc. Additionally or alternatively, average user activity, reporting, analytics, etc., can be presented by the utility gateway 210 to the customer via the central control panel 250.

In some examples, the example system 200 includes one or more wireless sensor devices capable of interfacing devices to utility providers without using a utility gateway, such as the utility gateway 210. Such wireless sensor devices can support, for example, management of remote devices, such as devices managed by a municipality, by a business enterprise, etc.

In the illustrated example, the utility pricing data communicated by the example utility pricing managers 205A-B to recipients (e.g., the example utility gateway 210, the example active control interfaces 235A-B, the example passive display interface 240, etc.) is not limited to any particular type of utility pricing data but, instead, can be any data related to the any type of pricing of any type of utility resource provided by any type of utility provider to any type of recipient (e.g., to any type of customer). In some examples, the utility pricing data includes data representing the cost(s), in any appropriate currency, to purchase a given utility resource at a particular time (or different times). For example, such utility pricing data can include numeric data representing the cost per kilowatt hour to purchase electricity at a particular time, the cost per gallon to purchase water at a particular time, the cost per cubic foot, per cubic meter, etc., to purchase natural gas at a particular time, etc.

Additionally or alternatively, in some examples, the utility pricing data includes data representing a price range, a price tier, etc., to purchase a given utility resource at a particular time (and/or data representing multiple price ranges/tiers corresponding to different times). For example, such utility pricing data can include alphanumeric data to indicate whether the cost(s) to purchase a given utility resource at a particular time (or times) corresponds to a first (e.g., normal) price range/tier, a second (e.g., discounted) price range/tier, a third (e.g., preferred) price range/tier, etc. Additionally or alternatively, in some examples, the utility pricing data includes one or more commands to cause a user interface, such as one or more of the example active control interfaces 235A-B, the example passive display interface 240, the example central control panel 250, etc., to display or otherwise present information indicative of the pricing of a given utility resource at a particular time (or times). For example, such utility pricing data can include one or more commands to cause a user interface to present different graphical icons, different colors (e.g., green, yellow, red, etc.) and/or color schemes, different audio tones and/or sounds, etc., corresponding to different price ranges/tiers for purchasing a given utility resource at a given time or times. In some examples, the price ranges/tiers for a given utility resource are determined autonomously by the corresponding utility provider and, as such, apply generally to a group of customers. In some examples, the price ranges/tiers for a given utility resource are negotiated between the corresponding utility provider and a particular customer and, as such, are customer specific.

As noted above, the utility pricing data communicated by the example utility pricing managers 205A-B to recipients (e.g., the example utility gateway 210, the example active control interfaces 235A-B, the example passive display interface 240, etc.) varies over time (e.g., corresponding to real-time utility pricing data, estimated utility pricing data at a particular future time, etc.). For example, and as noted above, the utility pricing managers 205A-B can update and/or predict the utility pricing data communicated to recipients in response to detection of one or more events associated with providing utility resources (e.g., electric power, water, natural gas, etc.), to customers' premises. Additionally or alternatively, the utility pricing managers 205A-B can update and/or predict the utility pricing data based on a time-of-day, such as when different price ranges/tiers are active at different times-of-day. Additionally or alternatively, the utility pricing managers 205A-B can update and/or predict the utility pricing data based on geographic location, such as when a given utility resource can be obtained by a utility provider from multiple, different geographic locations, and the cost for providing the utility resources varies across the different possible geographic locations. Additionally or alternatively, the utility pricing managers 205A-B can update and/or predict the utility pricing data based on the particular source of a utility resource, such as when a given utility resource can be obtained by a utility provider from multiple, different sources (e.g., such as solar, wind, coal, etc., in the case of electric power generation), and the cost for providing the utility resources varies across the different possible sources.

In some examples, recipients (e.g., the example utility gateway 210, the example active control interfaces 235A-B, etc.) are able to return utility pricing data back to the utility pricing managers 205A-B. For example, such utility pricing data can indicate whether a given utility price is acceptable to a customer. In some examples, a customer can use one of the example active control interfaces 235A-B associated with one of the example appliances 230A-B, and/or the central control panel 250 associated with the example utility gateway 210, to return such utility pricing data back to the utility pricing managers 205A-B. For example, the customer can use one of the example active control interfaces 235A-B (and/or the example central control panel 250) to activate an associated one of the example appliances 230A-B at a current time, which indicates that the customer accepts the current (e.g., real-time) utility price and agrees to purchase a given utility resource at that price. As another example, the customer can use one of the example active control interfaces 235A-B (and/or the example central control panel 250) to authorize the utility provider to activate an associated one of the example appliances 230A-B at a particular future time corresponding to an estimated future utility price, which indicates the customer accepts the estimated future utility price and agrees to purchase a given utility resource at that estimated price at that future time. In some examples, the customer can use one of the example active control interfaces 235A-B (and/or the example central control panel 250) to return utility pricing data in the form of feedback indicating the neither a current (e.g., real-time) nor an estimated future utility price is acceptable. In some such examples, the utility provider can use such feedback to further adjust (e.g., reduce, increase, etc.) the utility pricing data (e.g., the current and/or an estimated future utility price data) provided to one or more recipients. The foregoing and/or any other type(s) of utility pricing data are contemplated within the scope of real-time utility cost management, as disclosed herein.

Through a disclosed example system such as the example system 200 of FIG. 2, utility providers can adjust pricing in real-time, and even offer special pricing incentives if loads are not high. Utility providers can benefit from such a system because they can effectively manage load, and customers can benefit because they can make real-time decisions to save money. Furthermore, smart appliances implemented in accordance with teachings of this disclosure are able to interpret and leverage real-time utility cost data and utility company remote control commands to save customers money automatically.

Several innovative aspects can be achieved with a disclosed example system such as the example system 200 of FIG. 2. For example: (1) a utility provider can be given the ability to directly start/stop operation devices (e.g., appliances) based on real time utility load; (2) a customer can be given real time utility pricing at the point of decision (e.g., at the control interface of the appliance); (3) a gateway present at the customer premises can be leveraged for real time utility management; (4) real-time utility costs can be displayed on active control interfaces and/or passive display interfaces (e.g., at smart appliances, at utility deliver interfaces, etc.), etc.

Although the example system 200 is illustrated in FIG. 2 as including two example utility pricing managers 205A-B associated with two respective utility providers, one example utility gateway 210, one example network 215, one example network 225, two example active control interfaces 235A-B associated with two respective example appliances 230, one example passive display interface 240 associated with one example utility delivery interface 245, and one example central control panel 250, the example system 200 is not limited thereto. For example, the system 200 can include any number(s) and/or combination(s) of the example utility pricing manager(s) 205A-B, the example utility gateway(s) 210, the example network(s) 215, the example network(s) 225, the example active control interface(s) 235A-B, the example passive display interface(s) 240 and/or the example central control panel(s) 250.

A block diagram of an example active control interface 235 that may be used to implement one or more of the example active control interface(s) 235A-B of FIG. 2 is illustrated in FIG. 3. As described above, the example active control interface 235 can be implemented as an integrated component of a given appliance, as an external unit constructed to interface with one or more existing appliances (via an external interface of the existing appliance, via modification of an existing appliance to gain access to a communication interface, etc.), etc. The example active control interface 235 of FIG. 3 includes an example network transceiver 305 to connect to one or more communication networks, links, etc., such as the second example network 225 of FIG. 2. For example, the network transceiver 305 may include an example wireless transceiver capable of communicating via a WiFi network, a ZigBee network, a Bluetooth network, etc. The example network interface 305 can be implemented by any type(s), number(s) and/or combination(s) of network transceiver(s)/interface circuit(s), such as the example interface circuit 1220 of FIG. 12, which is described in further detail below.

The example active control interface 235 of FIG. 3 also includes an example display 310 to display data, such as real-time utility pricing data, and/or other utility related information, to a user. The example display 310 may be implemented by any type(s), number(s) and/or combination(s) of display/output devices, such as one or more of the example output devices 1224 of FIG. 12, which are described in further detail below. The example active control interface 235 of FIG. 3 also includes an example user interface 315 to accept input commands from a user. The example user interface 315 may be implemented by any type(s), number(s) and/or combination(s) of user interface/input devices, such as one or more of the example input devices 1222 of FIG. 12, which are described in further detail below.

To present real-time utility pricing data for real-time utility cost management in accordance with the teachings of this disclosure, the example active control interface 235 of FIG. 3 includes an example pricing presenter 320. The example pricing presenter 320 of the illustrated example accesses real-time utility pricing data received (e.g., via the example network transceiver 305) from one or more utility providers and corresponding to a first (e.g., current) time. For example, the utility pricing data may be relayed by the utility gateway 210 from the utility pricing manager(s) 205A-B of the utility providers to the active control interface 235. In the illustrated example, the example pricing presenter 320 also presents the real-time utility pricing data corresponding to the first (e.g., current) time on the example display 310.

To control appliance operation for real-time utility cost management in accordance with the teachings of this disclosure, the example active control interface 235 of FIG. 3 includes an example operation controller 325. In the illustrated example of FIG. 3, after the pricing presenter 320 presents the real-time utility pricing data corresponding to the first (e.g., current) time on the example display 310, the operation controller 325 determines, based on a first input received via the user interface, whether remote control of an appliance associated with the active control interface 235 (e.g., such as one of the example appliances 230A-B) is permitted. For example, the operation controller 325 may prompt a user to select, via the user interface 315, whether remote control of the appliance associated with the active control interface 235 is permitted. In some examples, in response to determining that remote control of the appliance is permitted (e.g., based on the input selection received via the user interface 315), the operation controller 325 delays activation of an operation of the appliance until receipt of a first command via the network transceiver 305 (e.g., such as an activation command received from the utility pricing manage(s) 205A-B of the utility provider providing the real-time utility pricing data). For example, the operation may correspond to turning the appliance on, starting a washing cycle for a clothes washer, staring a drying cycle for a clothes dryer, starting a cleaning cycle for a dishwasher, starting an ice making operation for a refrigerator, starting a pump for a pool filtration system, etc.

In some examples, after delaying the activation of the operation of the appliance, the operation controller 325 of the active control interface 235 activates the operation of the appliance in response to receipt of the first command via the network transceiver 305. For example, the first command may be an activation command sent by the utility pricing manage(s) 205A-B of the utility provider providing the real-time utility pricing data to the active control interface 235, and in response to the activation command, the operation controller 325 may (1) activate the appliance (e.g., by turning the appliance on), (2) activate an appliance operation previously selected/configured by a user via the user interface 315, (3) activate a preset operation, etc. In some such examples, after the operation of the appliance is activated, the operation controller 325 deactivates the activated operation of the appliance in response to receipt of a second command via the network transceiver 305. For example, the second command may be a deactivation command sent by the utility pricing manage(s) 205A-B of the utility provider providing the real-time utility pricing data to the active control interface 235, and in response to the deactivation command, the operation controller 325 may (1) deactivate the appliance (e.g., by turning the appliance off), (2) deactivate an appliance operation previously selected/configured by a user via the user interface 315, (3) deactivate a preset operation, etc. Accordingly, the operation controller 325 of the illustrated example interfaces with the control circuitry of the associated appliance to be able to control (e.g., activate/deactivate, etc.) operations of the appliance in response to commands received via the network transceiver 305 (e.g., from a utility provider).

In some examples, to incentivize a user to allow remote control of an appliance, the pricing presenter 320 of the active control interface 235 presents, on the example display 310, second utility pricing data expected to be charged for providing the utility resource (e.g., electric power, water, gas, etc.) to the appliance at a second time later than the first (e.g., current) time if the user permits the utility provider to remotely control the appliance at the second (e.g., later) time. In some such examples, the pricing presenter 320 receives the second (e.g., predicted future) utility pricing data with the first (e.g., current) utility pricing data from the utility pricing manager 205A-B of the appropriate utility provider (e.g., via the network transceiver 305). Additionally or alternatively, in some examples, when remote control of the appliance is permitted, the pricing presenter 320 presents, on the example display 310, third utility pricing data corresponding to real-time utility pricing data indicating an actual price to be charged for providing the utility resource to the appliance at the actual second time when the operation of the appliance is activated in response to the first command (e.g., the activation command) received from the appropriate utility provider. In some such examples, the pricing presenter 320 receives (e.g., via the network transceiver 305) the third utility pricing data from the utility pricing manager 205A-B of the appropriate utility provider with or otherwise in association with receipt of the first command (e.g., the activation command).

In some examples, the operation controller 325 of the active control interface 235 specifies, based on another input received via the user interface 315 (e.g., after the input indicating remote control of the appliance is permitted), a duration over which the operation of the appliance is to be active. In some such examples, the operation controller 325 transmits (e.g., via the network transceiver 305) information describing the duration over which the operation of the appliance is specified to be active to the utility pricing manager 205A-B of the appropriate utility provider. In some such examples, the operation controller 325 then activates and deactivates the operation of the appliance over a sequence of time intervals based on a sequence of commands received (e.g., via the network transceiver 305) from the utility pricing manager 205A-B of the appropriate utility provider. For example, the sequence of time intervals may cumulatively correspond to the duration over which the operation of the appliance is specified to be active.

To meter utility resource usage for real-time utility cost management in accordance with the teachings of this disclosure, the example active control interface 235 of FIG. 3 includes an example meter 330. In the illustrated example of FIG. 3, the meter 330 meters (e.g., measures, estimates, etc.) utility resource consumption by the appliance associated with the active control interface 235. For example, the meter 330 may include any appropriate metering technology to meter electric power usage, water usage, natural gas usage, etc. In the illustrated example of FIG. 3, the meter 330 reports (e.g., via the network transceiver 305) metering data representing the utility resource consumption associated with the appliance. For example, the meter 330 may report such metering data to one or more of the utility pricing manager 205A-B of the appropriate utility provider, the utility gateway 210 with which the active control interface 235 is in communication, etc. In some examples, the meter 330 additionally or alternatively displays such metering data on the display 310.

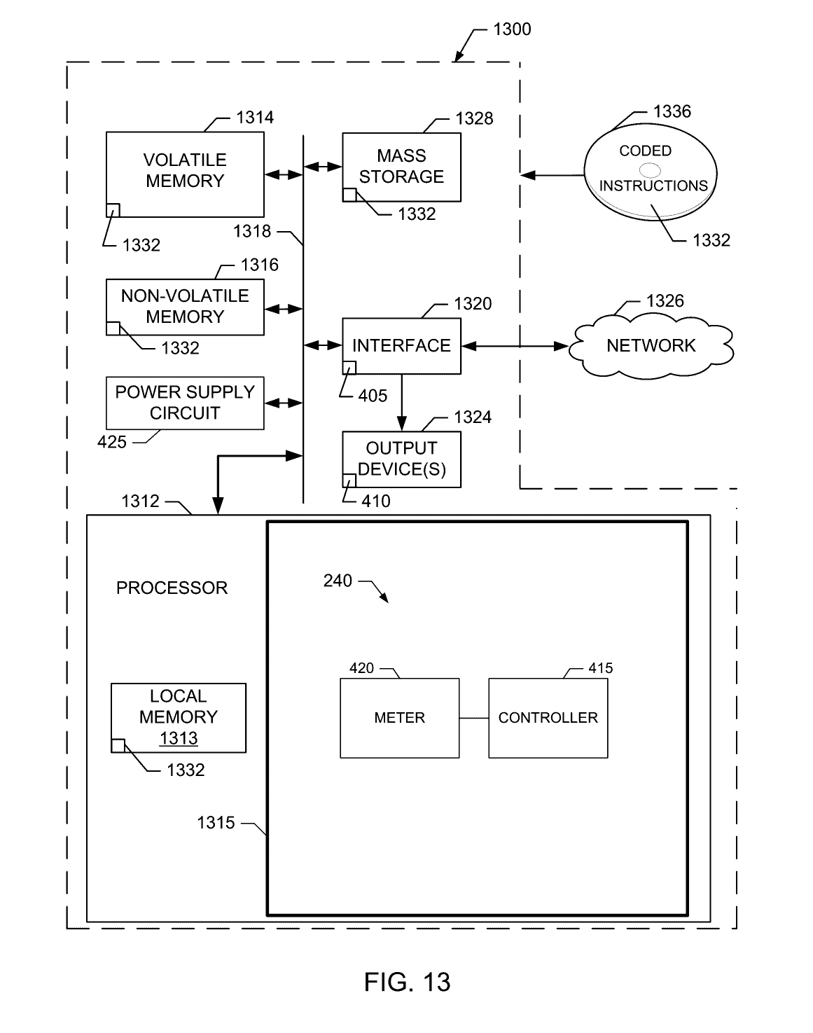

A block diagram of an example implementation of the example passive display interface 240 of FIG. 2 is illustrated in FIG. 4. The example passive display interface 240 of FIG. 4 includes an example network transceiver 405 to connect to one or more communication networks, links, etc., such as the second example network 225 of FIG. 2. For example, the network transceiver 405 may include an example wireless transceiver capable of communicating via a WiFi network, a ZigBee network, a Bluetooth network, etc. The example network transceiver 405 can be implemented by any type(s), number(s) and/or combination(s) of network transceiver(s)/interface circuit(s), such as the example interface circuit 1320 of FIG. 13, which is described in further detail below.

The example passive display interface 240 of FIG. 4 also includes an example display 410 to display data, such as real-time utility pricing data, and/or other utility related information, to a user. The example display 410 may be implemented by any type(s), number(s) and/or combination(s) of display/output devices, such as one or more of the example output devices 1324 of FIG. 13, which are described in further detail below.

The example passive display interface 240 of FIG. 4 further includes an example controller 415 to present, on the display 410, real-time utility pricing data for providing a utility resource to a utility delivery interface (e.g., such as electrical power to an electrical outlet, water to a water spigot, natural gas to a natural gas line, etc.). For example, the controller 415 of the illustrated example accesses real-time utility pricing data received from one or more utility providers (e.g., from one or more utility pricing manager(s) 205A-B) via the example network transceiver 405 and corresponding to a first (e.g., current) time. The example pricing controller 415 then presents the real-time utility pricing data corresponding to the first (e.g., current) time on the example display 410.

To meter utility resource usage for real-time utility cost management in accordance with the teachings of this disclosure, the example passive display interface 240 of FIG. 4 includes an example meter 420. In the illustrated example of FIG. 4, the meter 420 meters (e.g., measures, estimates, etc.) utility resource consumption at the utility delivery interface (e.g., the electrical outlet, the water spigot, the natural gas line, etc.) associated with the passive display interface 240. For example, the meter 420 may include any appropriate metering technology to meter electric power usage, water usage, natural gas usage, etc. In the illustrated example of FIG. 4, the meter 420 reports (e.g., via the network transceiver 405) metering data representing the utility resource consumption associated with the utility delivery interface. For example, the meter 420 may report such metering data to one or more of the utility pricing manager 205A-B of the appropriate utility provider, the utility gateway 210 with which the passive display interface 240 is in communication, etc. In some examples, the meter 420 additionally or alternatively displays such metering data on the display 410.

The example passive display interface 240 of FIG. 4 includes an example power supply circuit 425 to power one or more of the example network transceiver 405, the example display 410, the example controller 415 and/or the example meter 420. In the illustrated example of FIG. 4, the example passive display interface 240 is structured to be used with an electrical output (or similar electrical power utility interface). Accordingly, the example power supply circuit 425 is structured to electrically couple with wiring of the electrical outlet (or similar electrical power utility interface) in any appropriate manner to convert, condition and/or otherwise generate, from the electric outlet wiring, supply voltages, currents, etc., suitable for powering one or more of the example network transceiver 405, the example display 410, the example controller 415 and/or the example meter 420.

In some examples, the passive display interface 240 of FIG. 4 includes an example electrical plug 430 to electrically couple with an electrical socket of an electrical outlet being managed by or otherwise associated with the passive display interface 240. In some such examples, the electrical plug 430 also is electrically coupled with the example power supply circuit 425 to thereby electrically couple (via the plug 430) the power supply circuit 425 with the wiring of the electrical outlet. In some examples, the passive display interface 240 of FIG. 4 additionally or alternatively includes an example electrical socket 440 to electrically couple with the wiring of the electrical outlet being managed by or otherwise associated with the passive display interface 240 to thereby permit an appliance or other device to be electrically coupled with the electrical outlet. In some examples, the electrical socket 440 is electrically coupled to the example power supply circuit 425, which enables the electrical socket 440 to be electrically coupled with the wiring of the electrical outlet via the electrical plug 430. In some examples, the electrical socket 440 is electrically coupled to the electrical plug 430 without being electrically coupled to the power supply circuit 425.

In some examples, the passive display interface 240 of FIG. 4 includes an example housing 445 to house one or more of the example network transceiver 405, the example display 410, the example controller 415, the example meter 420, the example power supply circuit 425, the example electrical plug 430 and/or the example electrical socket 440.

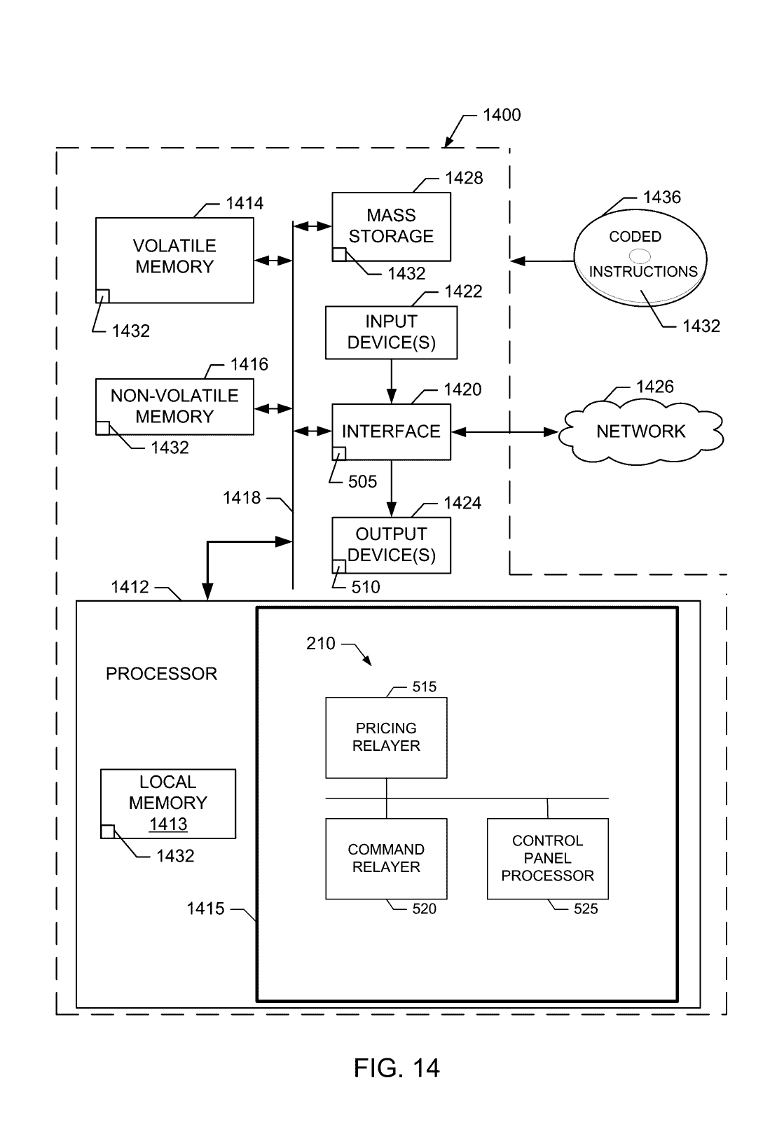

A block diagram of an example implementation of the example utility gateway 210 of FIG. 2 is illustrated in FIG. 5. The example utility gateway 210 of FIG. 5 includes an example network interface 505 to connect to one or more communication networks, links, etc., such as the first example network 215 and/or the second example network 225 of FIG. 2. For example, the network interface 505 may include an example wireless transceiver capable of communicating via a WiFi network, a ZigBee network, a Bluetooth network, etc., an Ethernet transceiver, an optical transceiver, a cable modem, etc. The example network interface 505 can be implemented by any type(s), number(s) and/or combination(s) of network transceiver(s)/interface circuit(s), such as the example interface circuit 1420 of FIG. 14, which is described in further detail below.

The example utility gateway 210 of FIG. 5 also includes an example display 510 to display data, such as real-time utility pricing data, and/or other utility related information, to a user. The example display 510 may be implemented by any type(s), number(s) and/or combination(s) of display/output devices, such as one or more of the example output devices 1424 of FIG. 14, which are described in further detail below.

To relay utility pricing data for real-time utility cost management in accordance with the teachings of this disclosure, the example utility gateway 210 of FIG. 5 includes an example pricing relayer 515. In the illustrated example of FIG. 5, the pricing relayer 515 accesses first (e.g., real-time) utility pricing data corresponding to a first (e.g., current) time provided by a utility company (e.g., by the utility pricing manage(s) 205A-B of the utility provider) via the first example network 215 (e.g., accessed using the network interface 505). The example pricing relayer 515 also relays, via the second example network 225 (e.g., accessed using the network interface 505), the first utility pricing data to, for example, one or more of the example active control interfaces 230A-B associated with one or more of the example appliances 230A-B, the passive display interface 240 associated with the example utility deliver interface 245, etc. In some examples, the pricing relayer 515 reformats the received utility pricing data according to an OIC utility framework prior to relaying the utility pricing data over the second example network 225.

To relay appliance control-related commands for real-time utility cost management in accordance with the teachings of this disclosure, the example utility gateway 210 of FIG. 5 includes an example command relayer 520. In the illustrated example of FIG. 5, the command relayer 520 relays a first command (e.g., an appliance activation command, etc.) received, after the utility pricing data corresponding to the first (e.g., current) time, from the utility provider via the first example network 215 (e.g., accessed using the network interface 505) to, for example, one or more of the example active control interfaces 230A-B associated with one or more of the example appliances 230A-B to control an operation of the appliance. In such examples, the command is relayed by the command relayer 520 via the second example network 225 (e.g., accessed using the network interface 505). In some examples, the command relayer 520 reformats the received commands according to an OIC utility framework prior to relaying the commands over the second example network 225.

In some examples, prior to the relaying of the first command, the command relayer 520 relays a second command, which is received via the second example network 225 (e.g., using the network interface 505) from the active control interface 235A-B associated with a respective one of the appliances 230A-B, to the utility provider (e.g., to the appropriate utility pricing manager 205A-B associated with the particular utility provider) via the first example network 215 (e.g., using the network interface 505). In some such examples, the second command specifies whether remote control of the particular appliance 230A-B is permitted.

In some examples, the first command described above, which is received by the command relayer 520, is an appliance activation command to activate an operation of the particular appliance 230A-B for which remote control is permitted. In some such examples, the command relayer 520 is further to relay a second command received from the utility provider (e.g., from the appropriate utility pricing manager 205A-B associated with the particular utility provider) via the first example network 215 to the active control interface 235A-B associated with the particular appliance 230A-B via the second example network 225 (e.g., using the network interface 505) to deactivate the operation of the appliance.

In some examples, the pricing relayer 515 of the example utility gateway 210 also accesses, via the first example network 215 (e.g., and from the appropriate utility pricing manager 205A-B associated with the particular utility provider), second utility pricing data expected to be charged for providing a utility resource to the particular appliance 230A-B at a second time later than the first (e.g., current) time under a condition that a user permits remote control of the appliance. In some such examples, the pricing relayer 515 further relays, via the second example network 225 (e.g., using the network interface 505), the second utility pricing data with the first utility pricing data to the active control interface 235A-B associated with the particular appliance 230A-B.

Additionally or alternatively, in some examples, the pricing relayer 515 of the example utility gateway 210 accesses, via the first example network 215 (e.g., and from the appropriate utility pricing manager 205A-B associated with the particular utility provider) third utility pricing data received in association with the first command (e.g., the activation command) described above. In some such examples, the third utility pricing data indicates an actual price to be charged for providing a utility resource to the particular appliance 230A-B at the actual time at which the utility provider controls operation of the particular appliance 230A-B via the first command. In some such examples, the pricing relayer 515 further relays, via the second example network 225 (e.g., using the network interface 505), the third utility pricing data to the active control interface 235A-B associated with the particular appliance 230A-B.

In some examples, the example utility gateway 210 of FIG. 5 includes an example control panel processor 525 to control operation of the example central control panel 250 of FIG. 2. In some such examples, the control panel processor 525 accesses metering data reported by respective ones of the active control interface 235A-B associated with respective ones of the appliances 230A-B. For example, such metering data may characterize utility resource consumption associated with the respective ones of the appliances 230A-B. In some such examples, the control panel processor 525 also presents the metering data on the example display 510 associated with the utility gateway 210. In some examples, the utility gateway 210 additionally or alternatively reports the received metering data to one or more utility providers via the example network interface 505.

A block diagram of an example utility pricing manager 205 that may be used to implement one or more of the example utility pricing managers 205A-B of FIG. 2 is illustrated in FIG. 6. The example utility pricing manager 205 of FIG. 6 includes an example network interface 605 to connect to one or more communication networks, links, etc., such as the first example network 215 of FIG. 2. For example, the network interface 605 may include an example wireless transceiver capable of communicating via a WiFi network, a ZigBee network, a Bluetooth network, etc., an Ethernet transceiver, an optical transceiver, a cable modem, etc. The example network interface 605 can be implemented by any type(s), number(s) and/or combination(s) of network transceiver(s)/interface circuit(s), such as the example interface circuit 1520 of FIG. 15, which is described in further detail below.

The example utility pricing manager 205 of FIG. 6 also includes an example pricing determiner 610 to transmit, via the first example network 115 (e.g., using the example network interface 605), real-time utility pricing data to one or more gateways, such as the example utility gateways 210, 210A and/or 210B, and/or one or more other recipients. For example, the pricing determiner 610 may determine and transmit first utility pricing data at a first time, and determine and transmit, via the first example network 115 (e.g., using the example network interface 605), second utility pricing data at a later second time to the one or more gateways.

In the illustrated example of FIG. 6, the pricing determiner 610 determines the utility pricing data (e.g., such as real-time utility pricing data, predicted future utility pricing data, etc.) based on detection of one or more events associated with providing a utility resource (e.g., such as electric power, water, natural gas, etc.). Accordingly, the example utility pricing manager 205 of FIG. 6 includes an example event detector 615 to detect one or more types of events associated with providing a utility resource. For example, the event detector 615 may be constructed to (1) receive alarm and/or other monitoring messages, and/or (2) include sensors/meters to monitor production and/or delivery of utility resource(s), etc., to detect events corresponding to occurrence of a fault condition, recovery from an overload condition, etc. In some such examples, the pricing determiner 610 may, for example, increase utility pricing in response to an event corresponding to occurrence of a fault condition, and in an amount related to (e.g., proportional to) the severity of the fault condition. As another example, the pricing determiner 610 may, for example, decrease utility pricing in response to an event corresponding to recovery from an overload condition, and in an amount to compensate for a pricing increase that occurred prior to recovery from the overload condition. Additionally or alternatively, the event detector 615 may include a timer configured to expire at one or more given intervals to trigger the pricing determiner 610 to periodically and/or aperiodically re-evaluate the utility pricing data to be transmitted to the one or more utility gateways in the system 200.

The example utility pricing manager 205 of FIG. 6 further includes an example appliance controller 620 to exchange appliance control messaging with one or more utility gateways. For example, the appliance controller 620 may receive, from a utility gateway via the first example network 115 (e.g., using the example network interface 605), a first command indicating that remote control of an appliance in communication with the gateway is permitted. For example, the appliance maybe one of the example appliances 230A-B associated with one of the example active control interface 235A-B. In some such examples, the appliance controller 620 may then transmit, to the utility gateway via the first example network 115 (e.g., using the example network interface 605), a second command to the gateway to control an operation of the appliance. In some examples, transmission of the second command is in response to detection, by the example event detector 615, of an event associated with providing a utility resource. For example, the appliance controller 620 may transmit an activation command to activate the operation of the appliance in response to detection of an event corresponding to recovery from an overload condition, recovery from a fault condition, real-time utility pricing meeting (e.g., falling below) a cost threshold, expiration of a timer, etc. As another example, the appliance controller 620 may transmit a deactivation command to deactivate the operation of the appliance in response to detection of an event corresponding to occurrence of an overload condition, occurrence of a fault condition, real-time utility pricing meeting (e.g., rising above) a cost threshold, expiration of a timer, etc.

In some examples, such as when the second command is to cause activation of the operation of the first appliance at a first time, the example pricing determiner 610 determines and transmits, via the first example network 215 (e.g., using the network interface 605), updated utility pricing data to the gateway, with the updated utility pricing data indicating an actual price to be charged for providing the utility resource to the appliance at the first time. Additionally or alternatively, in some examples, such as when the second command is to cause activation of the operation of the first appliance, the example appliance controller 620 transmits, via the first example network 215 (e.g., using the network interface 605), a third command to the utility gateway after the transmission of the second command to cause deactivation of the operation of the first appliance.

In some examples, the appliance controller 620 receives, via the first example network 215 (e.g., using the network interface 605), information from a utility gateway describing a duration over which an operation of an appliance in communication with the gateway is specified to be active. For example, the appliance may be a pool filtration system, and the information may describe an overall amount of time in a given 24-hour period (or some other period of time) during which the pool filtration system is to be active. In some such examples, the appliance controller 620 transmits, via the first example network 215 (e.g., using the network interface 605), a sequence of commands to the gateway to activate and deactivate the operation of the appliance over a sequence of time intervals, such that the sequence of time intervals cumulatively correspond to the duration over which the operation of the appliance is specified to be active. For example, the appliance controller 620 may transmit a sequence of activation and deactivation commands to cause activation of the appliance (e.g., the pool filtration system) during time intervals when a utility cost meets (e.g., falls below a threshold) until the specified overall duration of activation has been satisfied for the given time period (e.g., the 24 hour period, or some other period of time).

In the illustrated example of FIG. 6, the utility pricing manager 205 includes an example metering data logger 625 to receive metering data, via the first example network 215 (e.g., using the example network interface 605), from appliances, such as the example appliances 330A-B, and/or from gateways, such as the example utility gateway 210, etc. For example, the metering data may characterize utility resource consumption (e.g., electric power consumption, water consumption, natural gas consumption, etc.) by the respective appliances. In some such examples, the event detector 615 accesses the metering data received by the example metering data logger 625, and processes the metering data to detect the one or more events associated with providing one or more utility resources that were described above. For example, the event detector 615 may determine, from the metering data, that a rate of utility resource consumption is increasing for a group of appliances, indicating a possible overload condition is imminent. As another example, the event detector 615 may determine, from the metering data, that utility resource consumption is unusually low, indicating a possible fault condition has occurred. As yet another example, the event detector 615 may determine, from the metering data, that utility resource consumption is relatively constant and below a threshold, indicating an opportunity for incentivizing resource consumption at the current time (e.g., by lowering real-time utility prices) to shift load from possible later peak usage times.

While example manners of implementing the system 200 of FIG. 2 are illustrated in FIGS. 2-6, one or more of the elements, processes and/or devices illustrated in FIGS. 2-6 may be combined, divided, re-arranged, omitted, eliminated and/or implemented in any other way. Further, the example utility pricing managers 205, 205A and/or 205B, the example utility gateway 210, the example networks 215 and/or 225, the example active control interfaces 235, 235A and/or 235B, the example passive display interface 240, the example central control panel 250, the example network transceiver 305, the example display 310, the example user interface 315, the example pricing presenter 320, the example operation controller 325, the example meter 330, the example network transceiver 405, the example display 410, the example controller 415, the example meter 420, the example power supply circuit 425, the example network interface 505, the example display 510, the example pricing relayer 515, the example command relayer 520, the example control panel processor 525, the example network interface 605, the example pricing determiner 610, the example event detector 615, the example appliance controller 620, the example metering data logger 625 and/or, more generally, the example system 200 of FIGS. 2-6 may be implemented by hardware, software, firmware and/or any combination of hardware, software and/or firmware. Thus, for example, any of the example utility pricing managers 205, 205A and/or 205B, the example utility gateway 210, the example networks 215 and/or 225, the example active control interfaces 235, 235A and/or 235B, the example passive display interface 240, the example central control panel 250, the example network transceiver 305, the example display 310, the example user interface 315, the example pricing presenter 320, the example operation controller 325, the example meter 330, the example network transceiver 405, the example display 410, the example controller 415, the example meter 420, the example power supply circuit 425, the example network interface 505, the example display 510, the example pricing relayer 515, the example command relayer 520, the example control panel processor 525, the example network interface 605, the example pricing determiner 610, the example event detector 615, the example appliance controller 620, the example metering data logger 625 and/or, more generally, the example system 200 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example system 200, the example utility pricing managers 205, 205A and/or 205B, the example utility gateway 210, the example networks 215 and/or 225, the example active control interfaces 235, 235A and/or 235B, the example passive display interface 240, the example central control panel 250, the example network transceiver 305, the example display 310, the example user interface 315, the example pricing presenter 320, the example operation controller 325, the example meter 330, the example network transceiver 405, the example display 410, the example controller 415, the example meter 420, the example power supply circuit 425, the example network interface 505, the example display 510, the example pricing relayer 515, the example command relayer 520, the example control panel processor 525, the example network interface 605, the example pricing determiner 610, the example event detector 615, the example appliance controller 620 and/or the example metering data logger 625 is/are hereby expressly defined to include a tangible computer readable storage device or storage disk such as a memory, a digital versatile disk (DVD), a compact disk (CD), a Blu-ray disk, etc. storing the software and/or firmware. Further still, the example system 200 may include one or more elements, processes and/or devices in addition to, or instead of, those illustrated in FIGS. 2-6, and/or may include more than one of any or all of the illustrated elements, processes and devices.

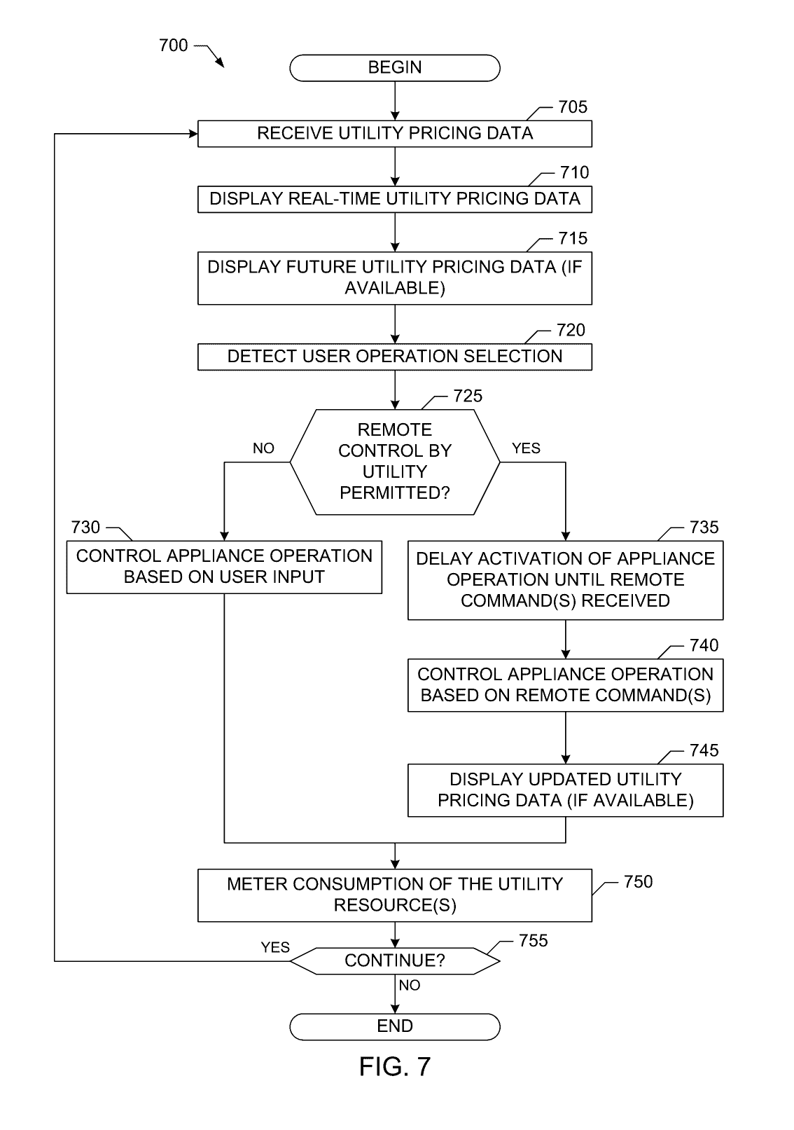

Flowcharts representative of example machine readable instructions for implementing the example system 200, the example utility pricing managers 205, 205A and/or 205B, the example utility gateway 210, the example networks 215 and/or 225, the example active control interfaces 235, 235A and/or 235B, the example passive display interface 240, the example central control panel 250, the example network transceiver 305, the example display 310, the example user interface 315, the example pricing presenter 320, the example operation controller 325, the example meter 330, the example network transceiver 405, the example display 410, the example controller 415, the example meter 420, the example power supply circuit 425, the example network interface 505, the example display 510, the example pricing relayer 515, the example command relayer 520, the example control panel processor 525, the example network interface 605, the example pricing determiner 610, the example event detector 615, the example appliance controller 620 and/or the example metering data logger 625 are shown in FIGS. 7-10. In these examples, the machine readable instructions comprise one or more programs for execution by a processor, such as the one or more of processors 1212, 1312, 1412 and/or 1512 shown in the example processor platforms 1200, 1300, 1400 and 1500 discussed below in connection with FIGS. 12-15. The one or more programs, or portion(s) thereof, may be embodied in software stored on a tangible computer readable storage medium such as a CD-ROM, a floppy disk, a hard drive, a digital versatile disk (DVD), a Blu-ray Disk™, or a memory associated with one or more of the processors 1212, 1312, 1412 and/or 1512, but the entire program or programs and/or portions thereof could alternatively be executed by a device other than the processors 1212, 1312, 1412 and/or 1512, and/or embodied in firmware or dedicated hardware (e.g., implemented by an ASIC, a PLD, an FPLD, discrete logic, etc.). Further, although the example program(s) is(are) described with reference to the flowcharts illustrated in FIGS. 7-10, many other methods of implementing the example system 200, the example utility pricing managers 205, 205A and/or 205B, the example utility gateway 210, the example networks 215 and/or 225, the example active control interfaces 235, 235A and/or 235B, the example passive display interface 240, the example central control panel 250, the example network transceiver 305, the example display 310, the example user interface 315, the example pricing presenter 320, the example operation controller 325, the example meter 330, the example network transceiver 405, the example display 410, the example controller 415, the example meter 420, the example power supply circuit 425, the example network interface 505, the example display 510, the example pricing relayer 515, the example command relayer 520, the example control panel processor 525, the example network interface 605, the example pricing determiner 610, the example event detector 615, the example appliance controller 620 and/or the example metering data logger 625 may alternatively be used. For example, with reference to the flowcharts illustrated in FIGS. 7-10, the order of execution of the blocks may be changed, and/or some of the blocks described may be changed, eliminated, combined and/or subdivided into multiple blocks.

As mentioned above, the example processes of FIGS. 7-10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7-10 may be implemented using coded instructions (e.g., computer and/or machine readable instructions) stored on a non-transitory computer and/or machine readable medium such as a hard disk drive, a flash memory, a ROM, a CD, a DVD, a cache, a RAM and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the terms “comprising” and “including,” and variants thereof, are open ended. Also, as used herein, the terms “computer readable” and “machine readable” are considered equivalent unless indicated otherwise.

An example program 700 that may be executed to implement the example active control interfaces 235, 235A and/or 235B of FIGS. 2-3 is represented by the flowchart shown in FIG. 7. For convenience and without loss of generality, the example program 700 is described from the perspective of the example active control interface 235 of FIG. 3 implementing the example active control interface 235A in the example system 200 of FIG. 2. With reference to the preceding figures and associated written descriptions, the example program 700 of FIG. 7 begins execution at block 705 at which the example pricing presenter 320 of the example active control interface 235 accesses utility pricing data received, via the example utility gateway 210, from one or more utility providers. At block 710, the pricing presenter 320 presents the real-time (e.g., current) utility pricing data, which was accessed at block 705, on the example display 310 of the active control interface 235. At block 715, the pricing presenter 320 also presents future utility pricing data, if available, on the display 310. For example, such future utility pricing data may correspond to a utility price expected to be charged to the customer at a future time if remote control of the example appliance associated with the active control interface 235 is permitted.

At block 720, the example operation controller 325 of the active control interface 235 detects a user input (e.g., entered via the example user interface 315 of the active control interface 235) selecting whether remote control of the appliance associated with the active control interface 235 is permitted. If remote control of the appliance is not permitted (block 725), then at block 730 the active control interface 235 controls operation of the appliance based on further user inputs received via the example user interface 315. However, if remote control of the appliance is permitted (block 725), then at block 735 the operation controller 325 delays activation of the appliance (and/or one or more operations performed by the appliance) until one or more commands are received, via the utility gateway 210, from the utility provider(s). At block 740, the operation controller 325 controls appliance operation (e.g., activation, deactivation, etc.) based on one or more subsequent commands received, via the utility gateway 210, from the utility provider(s). At block 745, the pricing presenter 320 presents updated utility pricing data, if received from the utility provider(s) via the utility gateway 210, which corresponds to, for example, time(s) at which the appliance is activated remotely by the utility provider.

At block 750, the example meter 330 of the active control interface 235 meters, displays and/or reports, as described above, consumption of one or more utility resources by the appliance associated with the active control interface 235. At block 755, if operation of the active control interface 235 is to continue, processing returns to block 705 and blocks subsequent thereto. Otherwise, execution of the example program 700 ends.

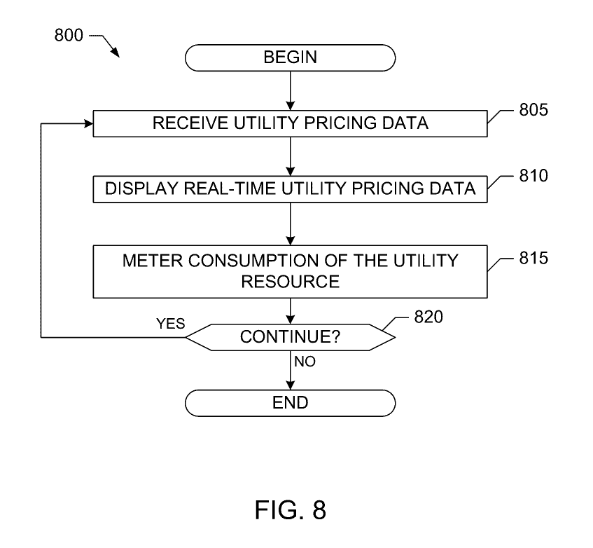

An example program 800 that may be executed to implement the example passive display interface 240 of FIGS. 2 and/or 4 is represented by the flowchart shown in FIG. 8. With reference to the preceding figures and associated written descriptions, the example program 800 of FIG. 8 begins execution at block 805 at which the example controller 415 of the passive display interface 240 accesses real-time (e.g., current) utility pricing data received, via the example utility gateway 210, from one or more utility providers. At block 810, the controller 415 presents the real-time utility pricing data, which was accessed at block 805, on the example display 410 of the passive display interface 240. At block 815, the example meter 420 of the passive display interface 240 meters, displays and/or reports, as described above, consumption of one or more utility resources at the utility delivery interface (e.g., electrical outlet, water spigot, natural gas line connection, etc.) associated with the passive display interface 240. At block 820, if operation of the passive display interface 240 is to continue, processing returns to block 805 and blocks subsequent thereto. Otherwise, execution of the example program 800 ends.

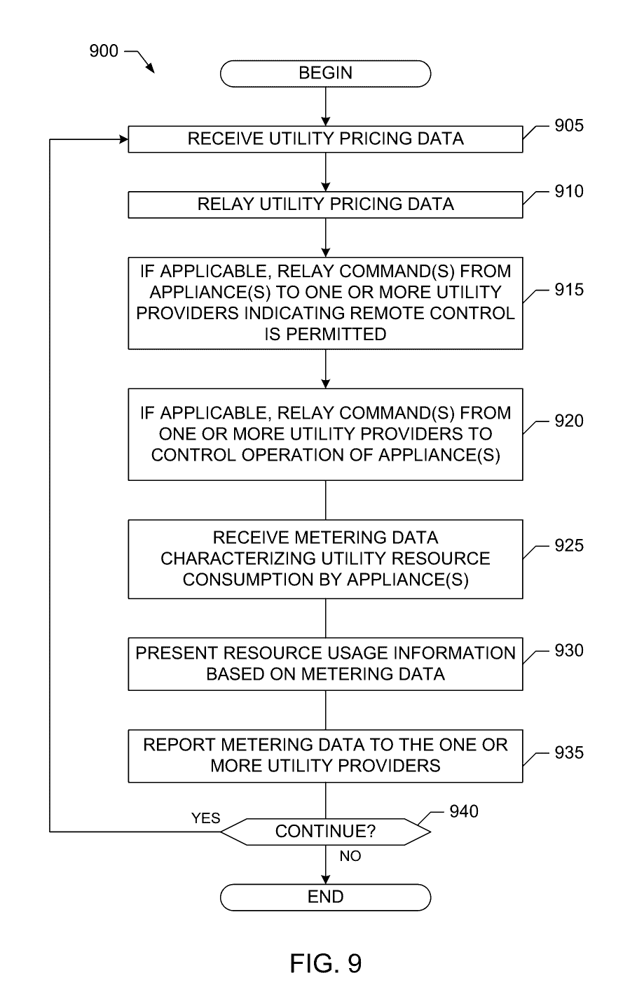

An example program 900 that may be executed to implement the example utility gateway 210 of FIGS. 2 and/or 5 is represented by the flowchart shown in FIG. 9. With reference to the preceding figures and associated written descriptions, the example program 900 of FIG. 9 begins execution at block 905 at which the example pricing relayer 515 of the example utility gateway 210 receives (e.g., via the first example network 215 using the example network interface 605) utility pricing data from one or more utility providers. At block 910, the pricing relayer 515 relays (e.g., via the second example network 225 using the example network interface 605) the utility pricing data to one or more active control interfaces (e.g., such as the example active control interfaces 235, 235A and/or 235B), passive display interfaces (e.g., such as the example passive display interface 240), smart appliances, etc., in communication with the utility gateway 210.

If applicable, at block 915, the example command relayer 520 of the utility gateway 210 relays command(s) received (e.g., via the second example network 225) from one or more active control interfaces (e.g., such as the example active control interfaces 235, 235A and/or 235B) to the utility provider(s) (e.g., via the first example network 215), with the command(s) indicating whether remote control of the appliance(s) associated with the active control interface(s) is permitted, as described above. If applicable, at block 920, the command relayer 520 relays commands received from the utility provider(s) (e.g., via the first example network 215) to the relevant active control interface(s) (e.g., via the second example network 225) to control operation(s) of the appliance(s) associated with the respective active control interface(s), as described above.

At block 925, the example control panel processor 525 of the utility gateway 210 accesses metering data reported by appliances (e.g., by the active control interface(s) associated with these appliances) that are in communication with the utility gateway 210. As described above, the metering data characterizes, for example, utility resource consumption by the respective appliances. At block 930, the control panel processor 525 presents the metering data on the example display 510 associated with the utility gateway 210. In some examples, at block 935, the utility gateway 210 additionally or alternatively reports the metering data to the utility provider(s) (e.g., via the example first network 215). At block 940, if operation of the utility gateway 210 is to continue, processing returns to block 905 and blocks subsequent thereto. Otherwise, execution of the example program 900 ends.

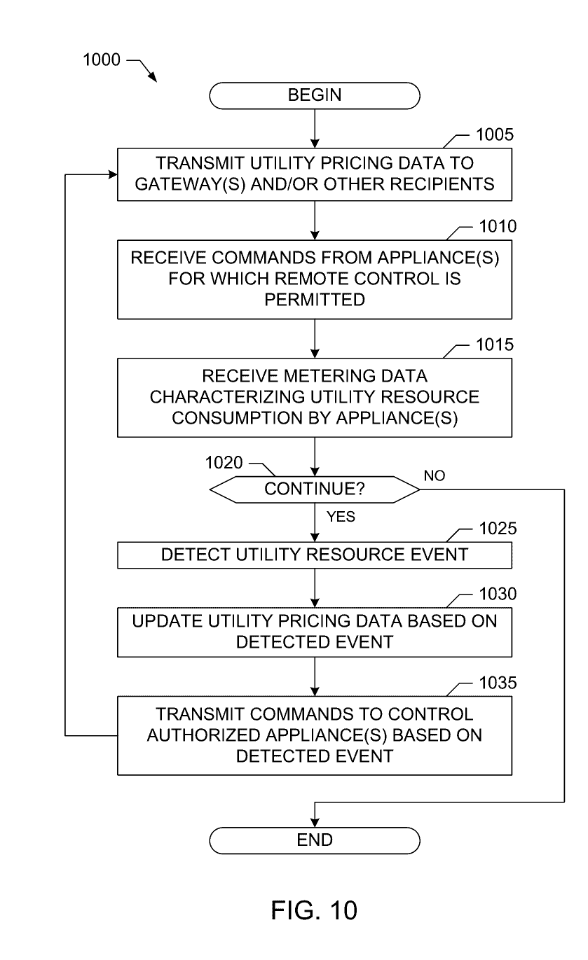

An example program 1000 that may be executed to implement the example utility pricing managers 205, 205A, and/or 205B of FIGS. 2 and/or 6 is represented by the flowchart shown in FIG. 10. For convenience and without loss of generality, the example program 1000 is described from the perspective of the example utility pricing manager 205 of FIG. 6 implementing the example utility pricing manager 205A in the example system 200 of FIG. 2. With reference to the preceding figures and associated written descriptions, the example program 1000 of FIG. 10 begins execution at block 1005 at which the example pricing determiner 610 of the utility pricing manager 205 transmits (e.g., via the first example network 215 using the example network interface 605) real-time utility pricing data (and/or expected future utility pricing data) to gateways, such as the example utility gateway 210, and/or other recipients in the system 200. At block 1010, the example appliance controller 620 of the utility pricing manager 205 receives (e.g., via the first example network 215 using the example network interface 605) commands from appliances (e.g., from active control interfaces, such as the example active control interfaces 235, 235A and/or 235B, associated with the appliances) indicating that remote control of the appliances is permitted. At block 1015, the example metering data logger 625 of the utility pricing manager 205 receives metering data (e.g., via the first example network 215 using the example network interface 605) characterizing utility resource consumption by appliances in the system 200, as described above.

At block 1020, if operation of the utility pricing manager 205 is to continue, processing proceeds to block 1025 at which example event detector 615 of the utility pricing manager 205 detects, as described above, one or more events associated with providing one or more utility resources. At block 1030, the pricing determiner 610 updates its real-time utility pricing data (and/or expected future utility pricing data) based on the detected event(s), as described above. At block 1035, the appliance controller 620 transmits (e.g., via the first example network 215) command(s) to control, based on the detected event(s), operation of the appliance(s) for which remote control is authorized. Processing then returns to block 1005 and blocks subsequent thereto.

However, if at block 1020 operation of the utility pricing manager 205 is to terminate, execution of the example program 1000 ends.

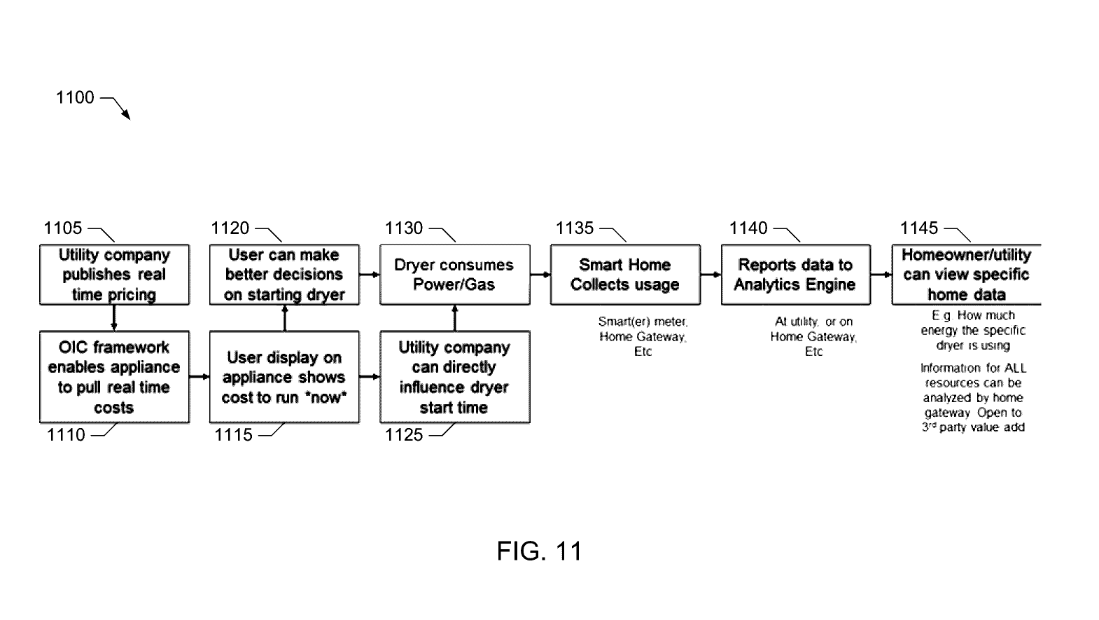

FIG. 11 illustrates an example real-time cost management process flow 1100 capable of being performed in the example system 200 of FIG. 2. The example process flow 1100 of FIG. 11 begins at block 1105 at which a utility provider transmits or otherwise publishes its real-time utility pricing data (e.g., via its utility pricing manager, such as the example utility pricing managers 205, 205A, and/or 205B). At block 1110, the example utility gateway 210 relays (e.g., according to its OIC utility framework) the real-time utility pricing data to an appliance including/implementing an active control interface, such as the example active control interfaces 235, 235A and/or 235B. At block 1115, the active control interface of the appliance displays the real-time utility pricing data. At block 1120, a user can use the displayed real-time utility pricing data to determine whether to start the appliance (e.g., a clothes dryer) now or permit the utility provider to remotely control the appliance. For example, if permitted by the user, at block 1125 the utility provider can remotely activate the appliance (e.g., the clothes dryer) at a time associated with lower utility costs.

At block 1130, the appliance (e.g., the clothes dryer) is activated and consumes a utility resource (e.g., natural gas). At block 1135, the gateway 210 collects metering data characterizing utility resource usage by the appliance(s) at the customer's premises. At block 1140, the gateway 210 reports the metering data to the utility pricing manager of the utility provider, which analyzes the metering data to detect events associated with providing utility resources, adjust utility pricing, etc. At block 1145, the gateway 210 displays the metering data using the example central control panel 250.

FIG. 12 is a block diagram of an example processor platform 1200 capable of executing the instructions of FIG. 7 to implement the example active control interfaces 235, 235A and/or 235B of FIGS. 2 and/or 3. The processor platform 1200 can be, for example, a server, a personal computer, a mobile device (e.g., a cell phone, a smart phone, a tablet such as an iPad™), a personal digital assistant (PDA), an Internet appliance, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. In the illustrated example of FIG. 12, the processor 1212 includes one or more example processing cores 1215 configured via example instructions 1232, which include the example instructions of FIG. 7, to implement the example pricing presenter 320, the example operation controller 325 and/or the example meter 330 of FIG. 3.

The processor 1212 of the illustrated example includes a local memory 1213 (e.g., a cache). The processor 1212 of the illustrated example is in communication with a main memory including a volatile memory 1214 and a non-volatile memory 1216 via a link 1218. The link 1218 may be implemented by a bus, one or more point-to-point connections, etc., or a combination thereof. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1200, can allow the user to control the computer system and provide data to the computer using physical gestures, such as, but not limited to, hand or body movements, facial expressions, and face recognition. In the illustrated example of FIG. 12, the input device(s) 1222 is(are) also structured to implement the example user interface 315 of FIG. 3.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip or a graphics driver processor. In the illustrated example of FIG. 12, the output device(s) 1224 is(are) also structured to implement the example display 310 of FIG. 3.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.). In the illustrated example of FIG. 12, the interface circuit 1220 is also structured to implement the example network transceiver 305 of FIG. 3.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID (redundant array of independent disks) systems, and digital versatile disk (DVD) drives. In some examples, the mass storage device 1228 and/or the volatile memory 1214 store real-time utility pricing data for use as disclosed herein

Coded instructions 1232 corresponding to the instructions of FIG. 7 may be stored in the mass storage device 1228, in the volatile memory 1214, in the non-volatile memory 1216, in the local memory 1213 and/or on a removable tangible computer readable storage medium, such as a CD or DVD 1236.

FIG. 13 is a block diagram of an example processor platform 1300 capable of executing the instructions of FIG. 8 to implement the example passive display interface 140 of FIGS. 2 and/or 4. The processor platform 1300 can be, for example, a server, a personal computer, a mobile device (e.g., a cell phone, a smart phone, a tablet such as an iPad™), a PDA, an Internet appliance, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer. In the illustrated example of FIG. 13, the processor 1312 includes one or more example processing cores 1315 configured via example instructions 1332, which include the example instructions of FIG. 8, to implement the example controller 415 and/or the example meter 420 of FIG. 4.

The processor 1312 of the illustrated example includes a local memory 1313 (e.g., a cache). The processor 1312 of the illustrated example is in communication with a main memory including a volatile memory 1314 and a non-volatile memory 1316 via a link 1318. The link 1318 may be implemented by a bus, one or more point-to-point connections, etc., or a combination thereof. The volatile memory 1314 may be implemented by SDRAM, DRAM, RDRAM and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a USB, and/or a PCI express interface.

One or more output devices 1324 are also connected to the interface circuit 1320 of the illustrated example. The output devices 1324 can be implemented, for example, by display devices (e.g., an LED, an OLED, a liquid crystal display, a CRT display, a touchscreen, a tactile output device, a printer and/or speakers). The interface circuit 1320 of the illustrated example, thus, typically includes a graphics driver card, a graphics driver chip or a graphics driver processor. In the illustrated example of FIG. 13, the output device(s) 1324 is(are) also structured to implement the example display 410 of FIG. 4.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.). In the illustrated example of FIG. 13, the interface circuit 1320 is also structured to implement the example network transceiver 405 of FIG. 4.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and DVD drives. In some examples, the mass storage device 1328 and/or the volatile memory 1314 store real-time utility pricing data for use as disclosed herein

Coded instructions 1332 corresponding to the instructions of FIG. 8 may be stored in the mass storage device 1328, in the volatile memory 1314, in the non-volatile memory 1316, in the local memory 1313 and/or on a removable tangible computer readable storage medium, such as a CD or DVD 1336.

FIG. 14 is a block diagram of an example processor platform 1400 capable of executing the instructions of FIG. 9 to implement the example utility gateway 210 of FIGS. 2 and/or 5. The processor platform 1400 can be, for example, a server, a personal computer, a mobile device (e.g., a cell phone, a smart phone, a tablet such as an iPad™), a PDA, an Internet appliance, a set top box, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors or controllers from any desired family or manufacturer. In the illustrated example of FIG. 14, the processor 1412 includes one or more example processing cores 1415 configured via example instructions 1432, which include the example instructions of FIG. 9, to implement the example pricing relayer 515, the example command relayer 520 and/or the example control panel processor 525 of FIG. 5.

The processor 1412 of the illustrated example includes a local memory 1413 (e.g., a cache). The processor 1412 of the illustrated example is in communication with a main memory including a volatile memory 1414 and a non-volatile memory 1416 via a link 1418. The link 1418 may be implemented by a bus, one or more point-to-point connections, etc., or a combination thereof. The volatile memory 1414 may be implemented by SDRAM, DRAM, RDRAM and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a USB, and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1400, can allow the user to control the computer system and provide data to the computer using physical gestures, such as, but not limited to, hand or body movements, facial expressions, and face recognition.

One or more output devices 1424 are also connected to the interface circuit 1420 of the illustrated example. The output devices 1424 can be implemented, for example, by display devices (e.g., an LED, an OLED, a liquid crystal display, a CRT display, a touchscreen, a tactile output device, a printer and/or speakers). The interface circuit 1420 of the illustrated example, thus, typically includes a graphics driver card, a graphics driver chip or a graphics driver processor. In the illustrated example of FIG. 14, the output device(s) 1424 is(are) also structured to implement the example display 510 of FIG. 5.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a digital subscriber line (DSL), a telephone line, coaxial cable, a cellular telephone system, etc.). In the illustrated example of FIG. 14, the interface circuit 1420 is also structured to implement the example network interface 505 of FIG. 5.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and DVD drives. In some examples, the mass storage device 1428 and/or the volatile memory 1414 store real-time utility pricing data for use as disclosed herein

Coded instructions 1432 corresponding to the instructions of FIG. 9 may be stored in the mass storage device 1428, in the volatile memory 1414, in the non-volatile memory 1416, in the local memory 1413 and/or on a removable tangible computer readable storage medium, such as a CD or DVD 1436.

FIG. 15 is a block diagram of an example processor platform 1500 capable of executing the instructions of FIG. 10 to implement the example utility pricing managers 205, 205A and/or 205B of FIGS. 2 and/or 6. The processor platform 1500 can be, for example, a server, a personal computer, a mobile device (e.g., a cell phone, a smart phone, a tablet such as an iPad™), a PDA, an Internet appliance, a set top box, or any other type of computing device.

The processor platform 1500 of the illustrated example includes a processor 1512. The processor 1512 of the illustrated example is hardware. For example, the processor 1512 can be implemented by one or more integrated circuits, logic circuits, microprocessors or controllers from any desired family or manufacturer. In the illustrated example of FIG. 15, the processor 1512 includes one or more example processing cores 1515 configured via example instructions 1532, which include the example instructions of FIG. 10, to implement the example pricing determiner 610, the example event detector 615, the example appliance controller 620 and/or the example metering data logger 625 of FIG. 6.

The processor 1512 of the illustrated example includes a local memory 1513 (e.g., a cache). The processor 1512 of the illustrated example is in communication with a main memory including a volatile memory 1514 and a non-volatile memory 1516 via a link 1518. The link 1518 may be implemented by a bus, one or more point-to-point connections, etc., or a combination thereof. The volatile memory 1514 may be implemented by SDRAM, DRAM, RDRAM and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a USB, and/or a PCI express interface.

In the illustrated example, one or more input devices 1522 are connected to the interface circuit 1520. The input device(s) 1522 permit(s) a user to enter data and commands into the processor 1512. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1500, can allow the user to control the computer system and provide data to the computer using physical gestures, such as, but not limited to, hand or body movements, facial expressions, and face recognition.

One or more output devices 1524 are also connected to the interface circuit 1520 of the illustrated example. The output devices 1524 can be implemented, for example, by display devices (e.g., an LED, an OLED, a liquid crystal display, a CRT display, a touchscreen, a tactile output device, a printer and/or speakers). The interface circuit 1520 of the illustrated example, thus, typically includes a graphics driver card, a graphics driver chip or a graphics driver processor.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a digital subscriber line (DSL), a telephone line, coaxial cable, a cellular telephone system, etc.). In the illustrated example of FIG. 15, the interface circuit 1520 is also structured to implement the example network interface 605 of FIG. 6.

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, RAID systems, and DVD drives. In some examples, the mass storage device 1528 and/or the volatile memory 1514 store real-time utility pricing data for use as disclosed herein

Coded instructions 1532 corresponding to the instructions of FIG. 10 may be stored in the mass storage device 1528, in the volatile memory 1514, in the non-volatile memory 1516, in the local memory 1513 and/or on a removable tangible computer readable storage medium, such as a CD or DVD 1536.

The following further examples, which include subject matter such as a method for real-time utility cost management, means for performing real-time utility cost management, at least one computer-readable medium including instructions that, when executed by a processor cause the processor to perform real-time utility cost management, and an apparatus and/or a system for real-time utility cost management, are disclosed herein.

Example 1 is a method for real-time utility cost management, which includes displaying, on a display associated with an appliance, utility pricing data received via a network. The method of example 1 also include, after displaying the utility pricing data, determining, based on a first input received via a user interface associated with the appliance, whether remote control of the appliance is permitted. The method of example 1 further includes, in response to determining that remote control of the appliance is permitted, delaying activation of an operation of the appliance until receipt of a first command via the network.

Example 2 includes the subject matter of example 1, wherein the first command is to be received from a utility provider providing the utility pricing data.

Example 3 includes the subject matter of example 1, and further includes, after delaying the activation of the operation of the appliance, activating the operation of the appliance in response to receipt of the first command via the network; and after the operation of the appliance is activated, deactivating the operation of the appliance in response to receipt of a second command via the network.

Example 4 includes the subject matter of example 1, wherein the utility pricing data is first pricing data associated with a first time, and further includes displaying second utility pricing data expected to be charged for providing a utility resource to the appliance at a second time later than the first time if remote control of the appliance is permitted, the second utility pricing data being received via the network.

Example 5 includes the subject matter of example 4, and further includes, when remote control of the appliance is permitted, displaying third utility pricing data received via the network in association with the first command, the third utility pricing data indicating an actual price to be charged for providing the utility resource to the appliance at the second time.

Example 6 includes the subject matter of example 1, and further includes specifying, based on a second input received via the user interface, a duration over which the operation of the appliance is to be active; transmitting, via the network, information describing the duration over which the operation of the appliance is specified to be active; and activating and deactivating the operation of the appliance over a sequence of time intervals based on a sequence of commands received via the network, the sequence of time intervals cumulatively corresponding to the duration over which the operation of the appliance is specified to be active.

Example 7 includes the subject matter of example 1, and further includes metering utility resource consumption associated with the appliance; and reporting the utility resource consumption associated with the appliance via the network.

Example 8 includes the subject matter of example 1 or example 2, and further includes after delaying the activation of the operation of the appliance, activating the operation of the appliance in response to receipt of the first command via the network; and after the operation of the appliance is activated, deactivating the operation of the appliance in response to receipt of a second command via the network.

Example 9 includes the subject matter of any one of examples 1, 2 or 8, wherein the utility pricing data is first pricing data associated with a first time, and further includes displaying second utility pricing data expected to be charged for providing a utility resource to the appliance at a second time later than the first time if remote control of the appliance is permitted, the second utility pricing data being received via the network.

Example 10 includes the subject matter of example 9, and further includes, when remote control of the appliance is permitted, displaying third utility pricing data received via the network in association with the first command, the third utility pricing data indicating an actual price to be charged for providing the utility resource to the appliance at the second time.

Example 11 includes the subject matter of example 1 or example 2, and further includes specifying, based on a second input received via the user interface, a duration over which the operation of the appliance is to be active; transmitting, via the network, information describing the duration over which the operation of the appliance is specified to be active; and activating and deactivating the operation of the appliance over a sequence of time intervals based on a sequence of commands received via the network, the sequence of time intervals cumulatively corresponding to the duration over which the operation of the appliance is specified to be active.

Example 12 includes the subject matter of any one of examples 1, 2, 8 or 11, and further includes metering utility resource consumption associated with the appliance; and reporting the utility resource consumption associated with the appliance via the network.

Example 13 is a tangible computer readable storage medium including computer readable instructions which, when executed, cause a processor to at least display, on a display associated with an appliance, utility pricing data received via a network; after displaying the utility pricing data, determine, based on a first input received via a user interface associated with the appliance, whether remote control of the appliance is permitted; and in response to determining that remote control of the appliance is permitted, delay activation of an operation of the appliance until receipt of a first command via the network.

Example 14 includes the subject matter of example 13, wherein the first command is to be received from a utility provider providing the utility pricing data.

Example 15 includes the subject matter of example 13, wherein the instructions, when executed, further cause the processor to, after the activation of the operation of the appliance is delayed, activate the operation of the appliance in response to receipt of the first command via the network; and after the operation of the appliance is activated, deactivate the operation of the appliance in response to receipt of a second command via the network.

Example 16 includes the subject matter of example 13, wherein the utility pricing data is first pricing data associated with a first time, and the instructions, when executed, further cause the processor to display second utility pricing data expected to be charged for providing a utility resource to the appliance at a second time later than the first time if remote control of the appliance is permitted, the second utility pricing data being received via the network.

Example 17 includes the subject matter of example 16, wherein when remote control of the appliance is permitted, the instructions, when executed, further cause the processor to display third utility pricing data received via the network in association with the first command, the third utility pricing data indicating an actual price to be charged for providing the utility resource to the appliance at the second time.

Example 18 includes the subject matter of example 13, wherein the instructions, when executed, further cause the processor to specify, based on a second input received via the user interface, a duration over which the operation of the appliance is to be active; transmit, via the network, information describing the duration over which the operation of the appliance is specified to be active; and activate and deactivate the operation of the appliance over a sequence of time intervals based on a sequence of commands received via the network, the sequence of time intervals cumulatively corresponding to the duration over which the operation of the appliance is specified to be active.

Example 19 includes the subject matter of example 13, wherein the instructions, when executed, further cause the processor to meter utility resource consumption associated with the appliance; and report the utility resource consumption associated with the appliance via the network.

Example 20 is a tangible computer readable storage medium including computer readable instructions which, when executed, cause a processor to perform the method defined in any one of examples 1, 2 or 8 to 12.

Example 21 is an appliance control interface to support real-time utility cost management for an appliance, which includes a display a user interface and a network transceiver. The appliance control interface of example 21 also includes a pricing presenter to access utility pricing data received via the network transceiver, and present the utility pricing data on the display. The appliance control interface of example 21 further includes an operation controller to after the pricing presenter presents the utility pricing data, determine, based on a first input received via the user interface, whether remote control of the appliance is permitted; and in response to determining that remote control of the appliance is permitted, delay activation of an operation of the appliance until receipt of a first command via the network transceiver.

Example 22 includes the subject matter of example 21, wherein the first command is to be received from a utility provider providing the utility pricing data.

Example 23 includes the subject matter of example 21, wherein the operation controller is further to after delaying the activation of the operation of the appliance, activate the operation of the appliance in response to receipt of the first command via the network transceiver; and after the operation of the appliance is activated, deactivate the operation of the appliance in response to receipt of a second command via the network transceiver.

Example 24 includes the subject matter of example 21, wherein the utility pricing data is first pricing data associated with a first time, and the pricing presenter is further to display second utility pricing data expected to be charged for providing a utility resource to the appliance at a second time later than the first time if remote control of the appliance is permitted, the second utility pricing data being received via the network transceiver.

Example 25 includes the subject matter of example 24, wherein the pricing presenter is further to display third utility pricing data received via the network transceiver in association with the first command when remote control of the appliance is permitted, the third utility pricing data indicating an actual price to be charged for providing the utility resource to the appliance at the second time.

Example 26 includes the subject matter of example 21, wherein the operation controller is further to specify, based on a second input received via the user interface, a duration over which the operation of the appliance is to be active; transmit, via the network transceiver, information describing the duration over which the operation of the appliance is specified to be active; and activate and deactivate the operation of the appliance over a sequence of time intervals based on a sequence of commands received via the network transceiver, the sequence of time intervals cumulatively corresponding to the duration over which the operation of the appliance is specified to be active.

Example 27 includes the subject matter of example 21, and further includes a meter to meter utility resource consumption associated with the appliance; and report the utility resource consumption associated with the appliance via the network transceiver.

Example 28 includes the subject matter of example 21 or example 22, wherein the operation controller is further to, after delaying the activation of the operation of the appliance, activate the operation of the appliance in response to receipt of the first command via the network transceiver; and after the operation of the appliance is activated, deactivate the operation of the appliance in response to receipt of a second command via the network transceiver.

Example 29 includes the subject matter of any one of examples 21, 22 or 28, wherein the utility pricing data is first pricing data associated with a first time, and the pricing presenter is further to display second utility pricing data expected to be charged for providing a utility resource to the appliance at a second time later than the first time if remote control of the appliance is permitted, the second utility pricing data being received via the network transceiver.

Example 30 includes the subject matter of example 29, wherein the pricing presenter is further to display third utility pricing data received via the network transceiver in association with the first command when remote control of the appliance is permitted, the third utility pricing data indicating an actual price to be charged for providing the utility resource to the appliance at the second time.

Example 31 includes the subject matter of example 21 or example 22, wherein the operation controller is further to specify, based on a second input received via the user interface, a duration over which the operation of the appliance is to be active; transmit, via the network transceiver, information describing the duration over which the operation of the appliance is specified to be active; and activate and deactivate the operation of the appliance over a sequence of time intervals based on a sequence of commands received via the network transceiver, the sequence of time intervals cumulatively corresponding to the duration over which the operation of the appliance is specified to be active.

Example 32 includes the subject matter of any one of examples 21, 22, 28 or 31, and further includes a meter to meter utility resource consumption associated with the appliance; and report the utility resource consumption associated with the appliance via the network transceiver.

Example 33 is an apparatus including a processor configured to perform a method as defined in any one of examples 1 to 12.

Example 34 is an apparatus to support real-time utility cost management for an appliance, which includes means for accessing utility pricing data received via a network transceiver; means for presenting the utility pricing data on a display; means for determining, after the pricing presenter presents the utility pricing data and based on a first input received via a user interface, whether remote control of the appliance is permitted; and means for delaying activation of an operation of the appliance in response to determining that remote control of the appliance is permitted and until receipt of a first command via the network transceiver.

Example 35 includes the subject matter of example 34, wherein the first command is to be received from a utility provider providing the utility pricing data.

Example 36 includes the subject matter of example 34 or example 35, and further includes means for activating the operation of the appliance after delaying the activation of the operation of the appliance and in response to receipt of the first command via the network transceiver; and means for deactivating the operation of the appliance after the operation of the appliance is activated and in response to receipt of a second command via the network transceiver.

Example 37 includes the subject matter of any one of examples 34 to 36, wherein the utility pricing data is first pricing data associated with a first time, and further includes means for displaying second utility pricing data expected to be charged for providing a utility resource to the appliance at a second time later than the first time if remote control of the appliance is permitted, the second utility pricing data being received via the network transceiver.

Example 38 includes the subject matter of example 37, and further includes means for displaying third utility pricing data received via the network transceiver in association with the first command when remote control of the appliance is permitted, the third utility pricing data indicating an actual price to be charged for providing the utility resource to the appliance at the second time.

Example 39 includes the subject matter of example 34 or example 35, and further includes means for specifying, based on a second input received via the user interface, a duration over which the operation of the appliance is to be active; means for transmitting, via the network transceiver, information describing the duration over which the operation of the appliance is specified to be active; and means for activating and deactivating the operation of the appliance over a sequence of time intervals based on a sequence of commands received via the network transceiver, the sequence of time intervals cumulatively corresponding to the duration over which the operation of the appliance is specified to be active.

Example 40 includes the subject matter of any one of examples 34 to 36 or 39, and further includes means for metering utility resource consumption associated with the appliance; and means for reporting the utility resource consumption associated with the appliance via the network transceiver.

Example 41 is a method for real-time utility cost management, which includes accessing, with a processor, real-time pricing data for providing electrical power to an electrical outlet, the real-time pricing data received via a network. The method of example 41 also includes displaying, on a display, the real-time pricing data, the processor and the display being powered by a power supply circuit electrically coupled with wiring of the electrical outlet.

Example 42 includes the subject matter of example 41, and further includes receiving the real-time pricing data via a wireless transceiver in communication with the processor and the network, the wireless transceiver being powered by the power supply circuit.

Example 43 includes the subject matter of example 42, wherein the power supply circuit is electrically coupled with a first electrical plug that is to electrically couple with a first electrical socket of the electrical outlet to thereby electrically couple with the wiring of the electrical outlet.

Example 44 includes the subject matter of example 43, wherein the processor, the display, the power supply circuit, the wireless transceiver and the first electrical plug are housed in a housing.

Example 45 includes the subject matter of example 44, wherein the housing further houses a second electrical socket electrically coupled to the first electrical plug.

Example 46 is a tangible computer readable storage medium including computer readable instructions which, when executed, cause a processor to perform the method defined in any one of examples 41 to 45.

Example 47 is an electrical outlet display interface for real-time utility cost management, which includes a display; a network transceiver; a controller to display, on the display, real-time utility pricing data for providing electrical power to an electrical outlet, the real-time utility pricing data received via the network transceiver; and a power supply circuit to electrically couple with wiring of the electrical outlet to power the display, the network transceiver and the controller.

Example 48 includes the subject matter of example 47, wherein the network transceiver includes a wireless transceiver.

Example 49 includes the subject matter of example 47, and further includes a first electrical plug to electrically couple with a first electrical socket of the electrical outlet; and electrically couple with the power supply circuit to thereby electrically couple the power supply circuit with the wiring of the electrical outlet.

Example 50 includes the subject matter of example 49, and further includes a housing to house the display, the network transceiver, the controller, the power supply circuit and the first electrical plug.

Example 51 includes the subject matter of example 50, wherein the housing is further to house a second electrical socket electrically coupled to the first electrical plug.

Example 52 is a method for real-time utility cost management, which includes accessing first utility pricing data provided by a utility provider via a first network. The method of example 52 also includes relaying, via a second network, the first utility pricing data to a control interface associated with an appliance. The method of example 52 further includes relaying a first command received, after the first utility pricing data, from the utility provider, via the first network, to the control interface associated with the appliance, via the second network, to control an operation of the appliance.

Example 53 includes the subject matter of example 52, and further includes, prior to the relaying of the first command, relaying a second command received from the control interface associated with the appliance, via the second network, to the utility provider, via the first network, to specify whether remote control of the appliance is permitted.

Example 54 includes the subject matter of example 52, wherein the first command is to activate the operation of the appliance, and further includes, after the relaying of the first command, relaying a second command received from the utility provider, via the first network, to the control interface associated with the appliance, via the second network, to deactivate the operation of the appliance.

Example 55 includes the subject matter of example 52, wherein the first utility pricing data is associated with a first time, and further includes accessing, via the first network, second utility pricing data expected to be charged for providing a utility resource to the appliance at a second time later than the first time if remote control of the appliance is permitted; and relaying, via the second network, the second utility pricing data with the first utility pricing data to the control interface associated with the appliance.

Example 56 includes the subject matter of example 55, and further includes accessing third utility pricing data received via the first network in association with the first command, the third utility pricing data indicating an actual price to be charged for providing a utility resource to the appliance at the second time; and relaying, via the second network, the third utility pricing data to the control interface associated with the appliance.

Example 57 includes the subject matter of example 52, and further includes displaying metering data reported by the appliance via the second network, the metering data characterizing utility resource consumption associated with the appliance.

Example 58 is a tangible computer readable storage medium including computer readable instructions which, when executed, cause a processor to perform the method defined in any one of examples 52 to 57.

Example 59 is a gateway to support real-time utility cost management, which includes a pricing relayer to access first utility pricing data provided by a utility provider via a first network, and relay, via a second network, the first utility pricing data to a control interface associated with an appliance. The gateway of example 59 also includes a command relayer to relay a first command received, after the first utility pricing data, from the utility provider, via the first network, to the control interface associated with the appliance, via the second network, to control an operation of the appliance.

Example 60 includes the subject matter of example 59, wherein prior to the relaying of the first command, the command relayer is further to relay a second command received from the control interface associated with the appliance, via the second network, to the utility provider, via the first network, to specify whether remote control of the appliance is permitted.

Example 61 includes the subject matter of example 59, wherein the first command is to activate the operation of the appliance, and after the relaying of the first command, the command relayer is further to relay a second command received from the utility provider, via the first network, to the control interface associated with the appliance, via the second network, to deactivate the operation of the appliance.

Example 62 includes the subject matter of example 59, wherein the first utility pricing data is associated with a first time, and the pricing relayer is further to access, via the first network, second utility pricing data expected to be charged for providing a utility resource to the appliance at a second time later than the first time if remote control of the appliance is permitted; and relay, via the second network, the second utility pricing data with the first utility pricing data to the control interface associated with the appliance.

Example 63 includes the subject matter of example 62, wherein the pricing relayer is further to access third utility pricing data received via the first network in association with the first command, the third utility pricing data indicating an actual price to be charged for providing a utility resource to the appliance at the second time; and relay, via the second network, the third utility pricing data to the control interface associated with the appliance.

Example 64 includes the subject matter of example 59, and further includes a control panel processor to access metering data reported by the appliance via the second network, the metering data characterizing utility resource consumption associated with the appliance; and display metering data on a display associated with the gateway.

Example 65 is a method for real-time utility cost management, which includes transmitting, via a network, first utility pricing data to a gateway, detecting an event associated with providing a utility resource, determining second utility pricing data based on the event, and transmitting, via the network, the second utility pricing data to the gateway.

Example 66 includes the subject matter of example 65, wherein the event corresponds to expiration of a timer.

Example 67 includes the subject matter of example 65, wherein the event corresponds to recovery from an overload condition.

Example 68 includes the subject matter of example 65, wherein the event corresponds to occurrence of a fault condition.

Example 69 includes the subject matter of example 65, and further includes receiving, via the network, a first command indicating that remote control of a first appliance in communication with the gateway is permitted; and in response to the detection of the event, transmitting, via the network, a second command to the gateway to control an operation of the first appliance.

Example 70 includes the subject matter of example 69, wherein the second command is to cause activation of the operation of the first appliance at a first time, and further includes transmitting, via the network, third utility pricing data to the gateway, the third utility pricing data indicating an actual price to be charged for providing the utility resource to the first appliance at the first time.

Example 71 includes the subject matter of example 69, wherein the second command is to cause activation of the operation of the first appliance, and further includes, after the transmission of the second command, transmitting, via the network, a third command to the gateway to cause deactivation of the operation of the first appliance.

Example 72 includes the subject matter of example 65, and further includes receiving, via the network, information describing a duration over which an operation of a first appliance is specified to be active; and transmitting, via the network, a sequence of commands to the gateway to activate and deactivate the operation of the first appliance over a sequence of time intervals, the sequence of time intervals cumulatively corresponding to the duration over which the operation of the first appliance is specified to be active.

Example 73 includes the subject matter of example 65, and further includes accessing metering data received from a plurality of appliances via the network, the metering data characterizing resource consumption associated with respective ones the plurality of appliances; and processing the metering data to detect the event.

Example 74 is a tangible computer readable storage medium including computer readable instructions which, when executed, cause a processor to perform the method defined in any one of examples 65 to 73.

Example 75 is an apparatus for real-time utility cost management, which includes a pricing determiner to transmit, via a network, first utility pricing data to a gateway, determine second utility pricing data based on detection of an event associated with providing a utility resource, and transmit, via the network, the second utility pricing data to the gateway. The apparatus of example 75 also includes an event detector to detect the event associated with providing the utility resource.

Example 76 includes the subject matter of example 75, wherein the event corresponds to expiration of a timer.

Example 77 includes the subject matter of example 75, wherein the event corresponds to recovery from an overload condition.

Example 78 includes the subject matter of example 75, wherein the event corresponds to occurrence of a fault condition.

Example 79 includes the subject matter of example 75, and further includes an appliance controller to receive, via the network, a first command indicating that remote control of a first appliance in communication with the gateway is permitted; and in response to the detection of the event, transmit, via the network, a second command to the gateway to control an operation of the first appliance.

Example 80 includes the subject matter of example 79, wherein the second command is to cause activation of the operation of the first appliance at a first time, and the pricing determiner is further to transmit, via the network, third utility pricing data to the gateway, the third utility pricing data indicating an actual price to be charged for providing the utility resource to the first appliance at the first time.

Example 81 includes the subject matter of example 79, wherein the second command is to cause activation of the operation of the first appliance, and after the transmission of the second command, the appliance controller is further to transmit, via the network, a third command to the gateway to cause deactivation of the operation of the first appliance.

Example 82 includes the subject matter of example 75, and further includes an appliance controller to receive, via the network, information describing a duration over which an operation of a first appliance is specified to be active; and transmit, via the network, a sequence of commands to the gateway to activate and deactivate the operation of the first appliance over a sequence of time intervals, the sequence of time intervals cumulatively corresponding to the duration over which the operation of the first appliance is specified to be active.

Example 83 includes the subject matter of example 75, wherein the event detector is further to access metering data received from a plurality of appliances via the network, the metering data characterizing resource consumption associated with respective ones the plurality of appliances; and process the metering data to detect the event.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method for real-time utility cost management, the method comprising:
displaying, on a display associated with an appliance, utility pricing data received via a network;
after displaying the utility pricing data, determining, with a processor and based on a first input received via a user interface associated with the appliance, whether remote control of the appliance is permitted; and
in response to determining that remote control of the appliance is permitted, delaying, with the processor, activation of an operation of the appliance until receipt of a first command via the network.

2. A method as defined in claim 1, wherein the first command is to be received from a utility provider providing the utility pricing data.

3. A method as defined in claim 1, further including:
after delaying the activation of the operation of the appliance, activating the operation of the appliance in response to receipt of the first command via the network; and
after the operation of the appliance is activated, deactivating the operation of the appliance in response to receipt of a second command via the network.

4. A method as defined in claim 1, wherein the utility pricing data is first pricing data associated with a first time, and further including displaying second utility pricing data expected to be charged for providing a utility resource to the appliance at a second time later than the first time if remote control of the appliance is permitted, the second utility pricing data being received via the network.

5. A method as defined in claim 4, further including, when remote control of the appliance is permitted, displaying third utility pricing data received via the network in association with the first command, the third utility pricing data indicating an actual price to be charged for providing the utility resource to the appliance at the second time.

6. A method as defined in claim 1, further including:
specifying, based on a second input received via the user interface, a duration over which the operation of the appliance is to be active;
transmitting, via the network, information describing the duration over which the operation of the appliance is specified to be active; and
activating and deactivating the operation of the appliance over a sequence of time intervals based on a sequence of commands received via the network, the sequence of time intervals cumulatively corresponding to the duration over which the operation of the appliance is specified to be active.

7. A method as defined in claim 1, further including:
metering utility resource consumption associated with the appliance; and
reporting the utility resource consumption associated with the appliance via the network.

8. A tangible computer readable storage medium comprising computer readable instructions which, when executed, cause a processor to at least:
display, on a display associated with an appliance, utility pricing data received via a network;
after displaying the utility pricing data, determine, based on a first input received via a user interface associated with the appliance, whether remote control of the appliance is permitted; and
in response to determining that remote control of the appliance is permitted, delay activation of an operation of the appliance until receipt of a first command via the network.

9. A tangible computer readable storage medium as defined in claim 8, wherein the first command is to be received from a utility provider providing the utility pricing data.

10. A tangible computer readable storage medium as defined in claim 8, wherein the instructions, when executed, further cause the processor to:
after the activation of the operation of the appliance is delayed, activate the operation of the appliance in response to receipt of the first command via the network; and
after the operation of the appliance is activated, deactivate the operation of the appliance in response to receipt of a second command via the network.

11. A tangible computer readable storage medium as defined in claim 8, wherein the utility pricing data is first pricing data associated with a first time, and the instructions, when executed, further cause the processor to display second utility pricing data expected to be charged for providing a utility resource to the appliance at a second time later than the first time if remote control of the appliance is permitted, the second utility pricing data being received via the network.

12. A tangible computer readable storage medium as defined in claim 11, wherein when remote control of the appliance is permitted, the instructions, when executed, further cause the processor to display third utility pricing data received via the network in association with the first command, the third utility pricing data indicating an actual price to be charged for providing the utility resource to the appliance at the second time.

13. A tangible computer readable storage medium as defined in claim 8, wherein the instructions, when executed, further cause the processor to:
specify, based on a second input received via the user interface, a duration over which the operation of the appliance is to be active;
transmit, via the network, information describing the duration over which the operation of the appliance is specified to be active; and
activate and deactivate the operation of the appliance over a sequence of time intervals based on a sequence of commands received via the network, the sequence of time intervals cumulatively corresponding to the duration over which the operation of the appliance is specified to be active.

14. A tangible computer readable storage medium as defined in claim 8, wherein the instructions, when executed, further cause the processor to:
meter utility resource consumption associated with the appliance; and
report the utility resource consumption associated with the appliance via the network.

15. An appliance control interface to support real-time utility cost management for an appliance, the appliance control interface comprising:
a display;
a user interface;
a network transceiver;
a pricing presenter to:
access utility pricing data received via the network transceiver; and
present the utility pricing data on the display; and
an operation controller to:
after the pricing presenter presents the utility pricing data, determine, based on a first input received via the user interface, whether remote control of the appliance is permitted; and
in response to determining that remote control of the appliance is permitted, delay activation of an operation of the appliance until receipt of a first command via the network transceiver.

16. An appliance control interface as defined in claim 15, wherein the first command is to be received from a utility provider providing the utility pricing data.

17. An appliance control interface as defined in claim 15, wherein the operation controller is further to:
after delaying the activation of the operation of the appliance, activate the operation of the appliance in response to receipt of the first command via the network transceiver; and
after the operation of the appliance is activated, deactivate the operation of the appliance in response to receipt of a second command via the network transceiver.

18. An appliance control interface as defined in claim 15, wherein the utility pricing data is first pricing data associated with a first time, and the pricing presenter is further to display second utility pricing data expected to be charged for providing a utility resource to the appliance at a second time later than the first time if remote control of the appliance is permitted, the second utility pricing data being received via the network transceiver.

19. An appliance control interface as defined in claim 18, wherein the pricing presenter is further to display third utility pricing data received via the network transceiver in association with the first command when remote control of the appliance is permitted, the third utility pricing data indicating an actual price to be charged for providing the utility resource to the appliance at the second time.

20. An appliance control interface as defined in claim 15, wherein the operation controller is further to:
specify, based on a second input received via the user interface, a duration over which the operation of the appliance is to be active;
transmit, via the network transceiver, information describing the duration over which the operation of the appliance is specified to be active; and
activate and deactivate the operation of the appliance over a sequence of time intervals based on a sequence of commands received via the network transceiver, the sequence of time intervals cumulatively corresponding to the duration over which the operation of the appliance is specified to be active.

21. An appliance control interface as defined in claim 15, further including a meter to:
meter utility resource consumption associated with the appliance; and
report the utility resource consumption associated with the appliance via the network transceiver.

22. An electrical outlet display interface for real-time utility cost management, the electrical outlet display interface comprising:
a display;
a network transceiver;
a controller to display, on the display, real-time utility pricing data for providing electrical power to an electrical outlet, the real-time utility pricing data received via the network transceiver; and
a power supply circuit to electrically couple with wiring of the electrical outlet to power the display, the network transceiver and the controller.

23. An electrical outlet display interface as defined in claim 22, further including a first electrical plug to:
electrically couple with a first electrical socket of the electrical outlet; and
electrically couple with the power supply circuit to thereby electrically couple the power supply circuit with the wiring of the electrical outlet.

24. An electrical outlet display interface as defined in claim 23, further including a housing to house the display, the network transceiver, the controller, the power supply circuit and the first electrical plug.

25. An electrical outlet display interface as defined in claim 24, wherein the housing is further to house a second electrical socket electrically coupled to the first electrical plug.
